(19) United States
(12) Patent Application Publication
(10) Pub. No.: US 2024/0154776 A1
(43) Pub. Date: May 9, 2024

(54) SINGLE DCI AND MULTIPLE TRP UNIFIED TCI ACTIVATION DESIGN

(71) Applicant: QUALCOMM Incorporated, San Diego, CA (US)

(72) Inventors: Tianyang BAI, Mountain View, CA (US); Yan Zhou, San Diego, CA (US); Junyi Li, Fairless Hills, PA (US); Tao Luo, San Diego, CA (US)

(21) Appl. No.: 18/499,712

(22) Filed: Nov. 1, 2023

Related U.S. Application Data
(60) Provisional application No. 63/422,342, filed on Nov. 3, 2022.
(60) Provisional application No. 63/447,844, filed on Feb. 23, 2023.

(51) Int. Cl. H04L 5/00; H04W 72/23

(52) U.S. Cl. CPC H04L 5/0096; H04W 72/23

(57) ABSTRACT

This disclosure provides systems, methods and apparatus, including computer storage media for communication between a base station with two transmit receive point (TRPs) and a UE based on a single DCI. The UE receives a single downlink control information (DCI) for the UE that is configured with a first unified transmission configuration indication (TCI) state for a first TRP and second unified TCI state for a second TRP. The DCI includes at least a first TCI field. The UE updates a configuration of at least one of the first unified TCI state to a first updated unified TCI state or the second unified TCI state to a second updated unified TCI state based on the at least one TCI field. The UE communicates with at least one of the first TRP or the second TRP based on the first updated unified TCI state or the second updated unified TCI state.

### CROSS-REFERENCE TO RELATED APPLICATIONS

This application claims priority to U.S. Provisional Application No. 63/422,342 titled “SINGLE DCI AND MULTIPLE TRP UNIFIED TCI ACTIVATION DESIGN,” filed Nov. 3, 2022, and to U.S. Provisional Application No. 63/447,844 titled “SINGLE DCI AND MULTIPLE TRP UNIFIED TCI ACTIVATION DESIGN,” filed Feb. 23, 2023, both of which is assigned to the assignee hereof, and incorporated herein by reference in their entireties.

### TECHNICAL FIELD

The present disclosure relates to wireless communications including single downlink control information (DCI) and multiple transmit receive point (TRP) unified transmission configuration indication (TCI) design.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for communicating with one or more TRPs based on one or more unified TCI states. The method includes receiving a single downlink control information (DCI) for the UE that is configured with a first unified transmission configuration indication (TCI) state for a first transmit receive point (TRP) and second unified TCI state for a second TRP, wherein the DCI includes at least a first TCI field. The method includes updating a configuration of at least one of the first unified TCI state to a first updated unified TCI state or the second unified TCI state to a second updated unified TCI state based on the at least one TCI field. The method includes communicating with at least one of the first TRP or the second TRP based on the first updated unified TCI state or the second updated unified TCI state.

The present disclosure also provides an apparatus (e.g., a UE) including a memory storing computer-executable instructions and at least one processor configured to execute the computer-executable instructions to perform at least one of the above methods, an apparatus including means for performing at least one of the above methods, and a non-transitory computer-readable medium storing computer-executable instructions for performing at least one of the above methods.

One innovative aspect of the subject matter described in this disclosure can be implemented in a method at a network node for communicating with a UE via one or more TRPs. The method includes transmitting a single downlink control information (DCI) to a user equipment (UE) that is configured with a first unified transmission configuration indication (TCI) state for a first transmit receive point (TRP) and second unified TCI state for a second TRP, wherein the DCI includes at least a first TCI field. The method includes updating a configuration of the UE for at least one of the first unified TCI state to a first updated unified TCI state or the second unified TCI state to a second updated unified TCI state based on the at least one TCI field. The method includes communicating with the UE via at least one of the first TRP or the second TRP based on the first updated unified TCI state or the second updated unified TCI state.

The present disclosure also provides an apparatus (e.g., a BS) including a memory storing computer-executable instructions and at least one processor configured to execute the computer-executable instructions to perform at least one of the above methods, an apparatus including means for performing at least one of the above methods, and a non-transitory computer-readable medium storing computer-executable instructions for performing at least one of the above methods.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system including an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 is a diagram illustrating an example disaggregated base station architecture.

FIG. 5 is a diagram illustrating a first example of transmissions involving multiple transmit-receive-points (TRPs).

FIG. 6 is a diagram illustrating an example downlink control information (DCI) for indicating a transmission configuration indication (TCI)state of one or more TRPs

FIG. 7 is a timing diagram illustrating example application times for TCI states.

FIG. 8 is a message diagram illustrating various messages for configuration of unified TCI states for two TRPs.

FIG. 9 is a conceptual data flow diagram illustrating the data flow between different means/components in an example BS.

FIG. 10 is a conceptual data flow diagram illustrating the data flow between different means/components in an example UE.

FIG. 11 is a flowchart of an example method for a UE to communicate with a base station having two TRPs based on a single DCI.

FIG. 12 is a flowchart of another example method for a UE to communicate with a base station having two TRPs based on a single DCI.

FIG. 13 is a flowchart of an example method for a network node to communicate with a UE via two TRPs based on a single TRP.

FIG. 14 is a flowchart of another example method for a network node to communicate with a UE via two TRPs based on a single TRP.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (JOT) network, such as a system utilizing 3G, 4G or 5G, or further implementations thereof, technology.

Conventionally, in a wireless communications network such as a 5G NR network, a transmission configuration indication (TCI) state is used to indicate properties of a transmission. For example, a TCI state may indicate a quasi-co-location (QCL) relationship between an antenna port and a reference signal. A TCI state may be indicated for each transmission. For example, a downlink control information (DCI) or semi-persistent scheduling (SPS) configuration for the transmission may indicate the TCI state. A TCI state for control channels can be separately configured. A unified TCI may be applicable to multiple transmissions and transmission types. For example, a downlink (DL) only unified TCI applies to at least UE dedicated physical downlink shared channel (PDSCH) and physical downlink control channel (PDCCH). An uplink (UL) only unified TCI applies to at least UE dedicated physical uplink shared channel (PUSCH) and physical uplink control channel (PUCCH). A joint UL/DL unified TCI state applies to at least PDSCH, PDCCH, PUSCH, and PUCCH. A unified TCI state may also be optionally configured by RRC to apply to: Non-UE dedicated PDCCH and PDSCH, aperiodic CSI-RS for channel state information (CSI), aperiodic CSI-RS for beam management (BM), sounding reference signal (SRS) for code-book or non-code-book antenna switching, or aperiodic SRS for BM.

A unified TCI state may be configured in RRC pools and activated by MAC -CE. For example, an RRC message may configure multiple TCI states. The MAC-CE may downselect the configured TCI states into a set of activated TCI states, each associated with a codepoint. A DCI such as DCI format 1_1 or 1_2 can indicate a unified TCI from the activated TCI states. For example, the DCI may include a TCI field indicating a codepoint.

The DCI specifying the unified TCI state may be a DCI of format 1_1 or 1_2 with or without scheduling of a downlink assignment. With downlink assignment, the TCI field in the DCI indicates the TCI for the downlink transmission. Without downlink assignment, the DCI may have a CRC scrambled with CS-RNTI, the redundancy version (RV) is set to all 1s, the modulation and coding scheme (MCS) is set to all 1s, and new data indicator (NDI) set to 0, and frequency domain resource assignment (FDRA) set to all is or all 0s. The TCI field indicates the TCI state ID (e.g., a codepoint) for an activated TCI state. A PDSCH-to-HARQ feedback timing indicator field may be used to indicate the time offset from the DCI to its ACK in PUCCH. The TDRA field may be used to derive a virtual PDSCH location, which is used to determine a location for the ACK information (acknowledging the DCI rather than a PDSCH). The TCI information may be applicable to a PDCCH after an activation time.

Unified TCI state has been limited to a single transmit-receive-point (TRP) associated with a single unified TCI state. Accordingly, current unified TCI state cannot be used to configure transmissions involving multiple TRPs. Therefore, there is a need for signaling to allow configuration of a unified TCI state when a base station is associated with multiple TRPs.

In an aspect, the present disclosure provides for configuration, updating, and selection of TCI states for multiple TRPs using a single DCI. The UE may be configured with a first unified TCI state for a first TRP and a second unified TCI state for a second TRP. The unified TCI states may initially be configured as discussed above with an RRC configuration and a MAC-CE that downselects a set of active TCI states. The UE may receive a single DCI that includes at least one TCI field. The UE may determine whether the TCI field is applicable to the first unified TCI state, the second unified TCI state, or both. The UE may update the configuration of at least one of the first TCI state or the second TCI state based on the unified TCI states to which the TCI field is applicable. The UE may then communicate with at least one of the first TRP or the second TRP based on an updated TCI state.

In one aspect, the DCI may include a dynamic TCI state indication field that indicates whether the first unified TCI state or the second unified TCI state is applicable to a PDSCH reception. The UE may receive the PDSCH reception using the indicated TCI state starting from an application time after the DCI. That is, the UE may use the indicated TCI state to receive a PDSCH reception scheduled by the DCI or other scheduling.

In an aspect, where the UE is operating in a multiple TRP mode and the DCI includes a single TCI field, the UE may remain in the multiple TRP mode. One of the TCI states is updated based on the single TCI field. In some implementations, a default rule indicates which TCI states to use for a PDSCH reception. The UE proceeds to communicate using both TRPs.

Particular implementations of the subject matter described in this disclosure can be implemented to realize one or more of the following potential advantages. A single DCI to configure multiple TCI states may simplify signaling for multiple TRPs. The UE may be configured with fewer control resource sets (CORESETS) to search for the DCI and may search for fewer DCI formats, which may save power and/or use resources more efficiently. Further, the use of multiple TRPs may improve reliability and/or throughput.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

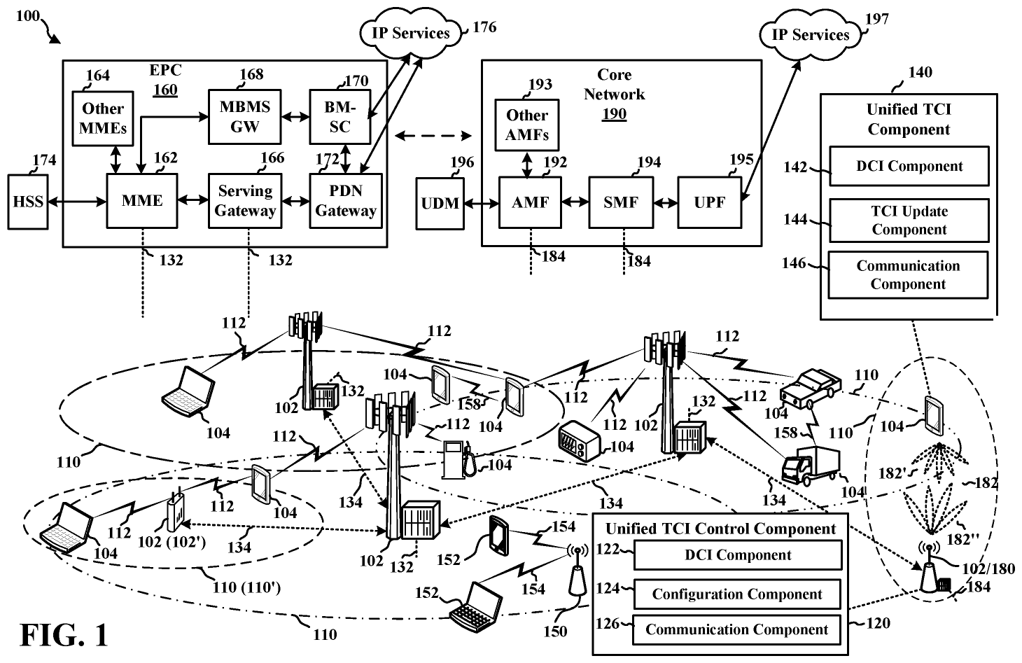

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs. A network node may include one or more of a base station 102, CU, DU, or RU.

In some implementations, one or more of the UEs 104 may include a unified TCI component 140 that is configured to communicate via two TRPs based on a single DCI. The unified TCI component 140 includes a DCI component 142 that is configured to receive a single DCI for the UE that is configured with a first unified TCI state for a TRP and second unified TCI state for a second TRP. The DCI includes at least a first TCI field. The unified TCI component 140 includes a TCI update component 144 configured to update a configuration of at least one of the first unified TCI state to a first updated unified TCI state or the second unified TCI state to a second updated unified TCI state based on the at least one TCI field. The unified TCI component 140 includes a communication component 146 configured to communicate with at least one of the first TRP or the second TRP based on the first updated unified TCI state or the second updated unified TCI state. In some implementations, the DCI includes a dynamic TCI selection field that indicates whether the first unified TCI state or the second unified TCI state is applicable to a PDSCH reception starting from an application time after the single DCI. In such implementations, the communication component 146 is configured to receive the PDSCH reception after the application time with at least one of the first TRP or the second TRP based on the first unified TCI state or the second unified TCI state as indicated by the dynamic TCI selection field.

In some implementations, one or more of the base stations 102 may include a unified TCI control component 120 that is configured to indicate unified TCI states for two TRPs with a single DCI. The unified TCI control component 120 may include a DCI component 122 configured to transmit a single DCI to the UE that is configured with a first unified TCI state for a first TRP and second unified TCI state for a second TRP. The DCI includes at least a first TCI field. The unified TCI control component 120 includes a configuration component 124 that is configured to update a configuration of the UE for at least one of the first unified TCI state to a first updated unified TCI state or the second unified TCI state to a second updated unified TCI state based on the at least one TCI field. The unified TCI control component 120 includes a communication component 126 that is configured to communicate with the UE via at least one of the first TRP or the second TRP based on the first updated unified TCI state or the second updated unified TCI state. In some implementations, the DCI includes a dynamic TCI selection field that indicates whether the first unified TCI state or the second unified TCI state is applicable to a physical downlink shared channel (PDSCH) reception starting from an application time after the single DCI. In such implementations, the communication component 126 is configured to transmit the PDSCH after the application time via at least one of the first TRP or the second TRP based on the first unified TCI state or the second unified TCI state as indicated by the dynamic TCI selection field.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 134 (such as X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies including future 6G technologies.

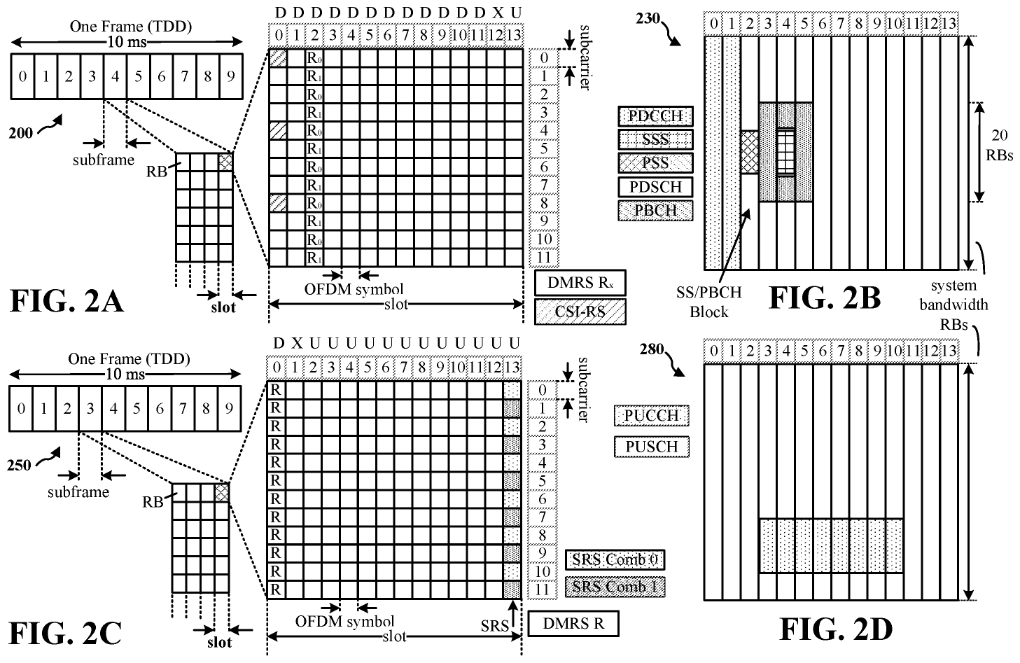

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one. In an aspect, a narrow bandwidth part (NBWP) refers to a BWP having a bandwidth less than or equal to a maximum configurable bandwidth of a BWP. The bandwidth of the NBWP is less than the carrier system bandwidth.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2g slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R x for one particular configuration, where 100x is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a L1 identity. A secondary synchronization signal (SSS) may be within symbol 4 of particular subframes of a frame. The SSS is used by a UE to determine a L1 cell identity group number and radio frame timing. Based on the L1 identity and the L1 cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RB s in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

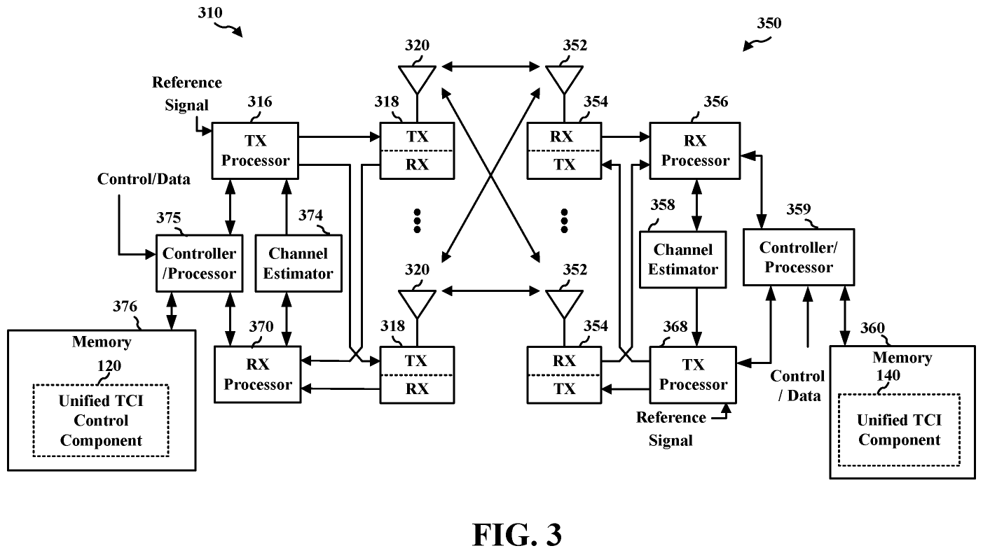

FIG. 3 is a diagram of an example of a base station 310 and a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase- shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality. The controller/processor 359 can be associated with a memory 360 that stores program

codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

At least one of the TX processor 368, the RX processor 356, and the controller/processor 359 may be configured to perform aspects in connection with the unified TCI component 140 of FIG. 1. For example, the memory 360 may include executable instructions defining the unified TCI component 140. The TX processor 368, the RX processor 356, and/or the controller/processor 359 may be configured to execute the unified TCI component 140.

At least one of the TX processor 316, the RX processor 370, and the controller/processor 375 may be configured to perform aspects in connection with the unified TCI control component 120 of FIG. 1. For example, the memory 376 may include executable instructions defining the unified TCI control component 120. The TX processor 316, the RX processor 370, and/or the controller/processor 375 may be configured to execute the unified TCI control component 120.

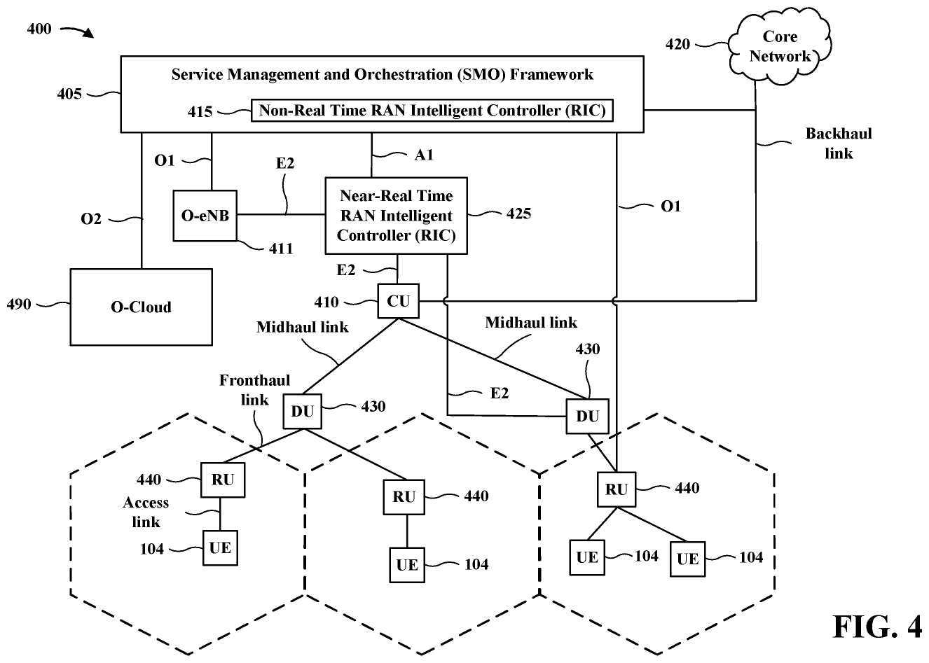

FIG. 4 is a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

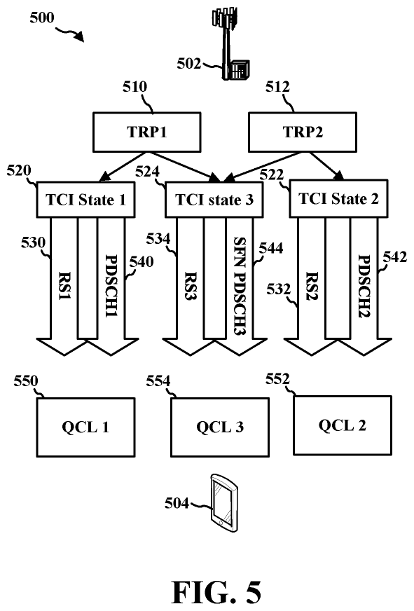

FIG. 5 is a diagram 500 illustrating an example of transmissions involving multiple TRPs. A base station 502 may include two or more TRPs (e.g., a first TRP 510 and a second TRP 512). The base station 502 may define various TCI states, which may be configured for the UE 504 via RRC signaling and activated via MAC-CE and/or DCI signaling. For example, the base station 502 may configure a first TCI state 520 associated with the first TRP 510 and a second TCI state 522 associated with the second TRP 512. In each of the TCI states 520 and 522, the respective TRP may transmit a reference signal 530, 532. The UE 504 may determine a respective QCL 550, 552 based on the reference signal and use the respective QCL 550, 552 for receiving the respective downlink signal (e.g., PDSCH 440, 442.)

In an aspect, when a base station includes multiple TRPs, a downlink transmission may be from one of the TRPs, from both TRPs separately, or from both TRPs as a single-frequency network (SFN) transmission. For instance, if the base station 502 transmits from a single TRP (e.g., TRP 510), the UE 504 may receive the transmission (e.g., PDSCH 540) based on TCI state 520 and associated QCL 550. When the base station transmits from both TRPs separately, the PDSCH 540 and the PDSCH 542 may be associated with different beams. Further, the PDSCH 540 and the PDSCH 542 may be transmitted on different DMRS ports, different layers, or different resource blocks and symbols. The UE 504 may receive each of the PDSCH 540 and the PDSCH 542 separately using the respective TCI state 520, 522 and corresponding QCL 550, 552.

For SFN transmissions, the base station 502 may configure a third TCI state 524 in which the base station transmits jointly from both of the first TRP 510 and the second TRP 512. In the third TCI state 524, both the first TRP 510 and the second TRP 512 may transmit a third reference signal 534 as an SFN transmission. The UE 504 may receive the third reference signal 534, determine a third QCL 554, and receive the SFN PDSCH 544 based on the third QCL 554. Accordingly, the SFN transmission is transparent to the UE 504 because the UE 504 determines the QCL from the reference signal in the same manner for both single TRP transmissions and SFN transmissions.

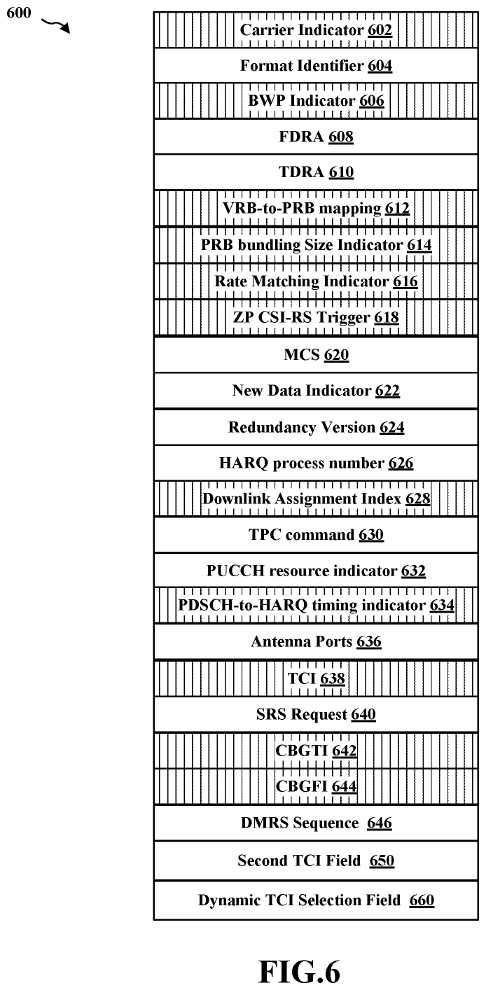

FIG. 6 is a diagram illustrating an example DCI 600 for indicating a TCI state of one or more TRPs. The DCI 600 may be based on DCI format 1_1 and may be used for scheduling a downlink transmission. In some implementations, DCI format 1_1 may be extended to include the information discussed herein, or a new DCI format may be defined for providing transmission parameters for different transport block types. In some implementations, a DCI format 1_2 may include similar fields. Additionally, the DCI format 1_1 or DCI format 1_2 may have a CRC scrambled with CS -RNTI and include fixed values in some fields to indicate a TCI configuration update without downlink scheduling. A DCI that indicates a TCI configuration, with or without downlink scheduling, may be referred to as a beam indication instance.

The DCI 600 may include multiple fields such as a carrier indicator field 602, a format identifier field 604, a BWP indicator field 606, a FDRA field 608, a TDRA field 610, a VRB-to-PRB mapping field 612, a PRB bundling size indicator field 614, a rate matching indicator field 616, a ZP CSI-RS trigger field 618, a MCS field 620, a new data indicator field 622, a redundancy version field 624, a HARQ process number field 626, a downlink assignment index field 628, a TPC command field 630, a PUCCH resource indicator field 632, a PDSCH-to-HARQ timing indicator field 634, antenna ports field 636, a TCI field 638, a SRS request field 640, a CBGTI field 642, a CBGFI field 644, and/or a DMRS sequence field 646. In some implementations, some fields (e.g., indicated with a vertical fill pattern) are optional or variable length depending on higher layer configured parameters.

In some implementations, when the base station (e.g., base station 502) is configured with a first TRP 510 and a second TRP 512, the TCI field 638 may indicate one or more DL, UL, or joint unified TCI state(s) for one of the two TRPs or both TRPs in a component carrier (CC) or bandwidth part (BWP) or a set of CCs/BWPs in a CC list. For instance, the carrier indicator field 602 or the BWP indicator field 606 may indicate the CC/BWP. In some implementations, the TCI field 638 may indicate one DL, UL, or joint unified

TCI state for only one of the two TRPs in a component carrier (CC) or bandwidth part (BWP) or a set of CCs/BWPs in a CC list. In such implementations, further information may be needed to indicate which of the two TRPs the TCI field 638 is applicable to. For example, the DCI 600 may include a dynamic TCI selection field 660 to associate the TCI field 638 to one of the first TRP 510 or the second TRP 512, or a unified TCI state associated therewith. As another example, a second TCI field 650 may be included to indicate a TCI state for the second TRP 512 and the TCI field 638 may be understood to indicate the TCI state for the first TRP 510.

Receiving a DCI with a single TCI field when the base station is configured with a first TRP 510 and a second TRP 512 may involve interpretation by the UE 104. In some implementations, the UE may be configured to interpret the DCI with a single TCI field to indicate a single TRP mode in which only the indicated TCI state is used. In some implementations, the UE may assume that the multiple TRP mode is still used, but only one of the unified TCI states is updated based on the single TCI field. The UE may be configured by RRC configuration or according to a rule to interpret the DCI with a single TCI field.

In some implementations, when the UE is configured with the multiple TRP mode (e.g., with a unified TCI state for both the first TRP 510 and the second TRP 512) not all PDSCH assignments will use both indicated TCIs. For example, the base station 502 may determine to use a single TRP transmission of the PDSCH 540 from the first TRP 510. A DCI field in a DCI format 1_1/1_2 may be used to indicate which of the indicated joint/DL TCI state(s) the UE shall apply for PDSCH reception starting from an application time (if defined) after the DCI format 1_1/1_2. For instance, the DCI field may be the dynamic TCI selection field 660.

The dynamic TCI selection field 660 may indicate which TCI state to use if two unified TCI states are indicated for a scheduled or activated PDSCH. In some implementations, the effect of the dynamic TCI selection field 660 may be sticky. That is, the TCI state indicated by the dynamic TCI selection field 660 may be used for all subsequent PDSCHs until the selection is changed. In some implementations, where the DCI 600 including the dynamic TCI selection field 660 schedules the PDSCH, the effect of the dynamic TCI selection field 660 may apply only to the scheduled PDSCH. The dynamic TCI selection field 660 may be an optional field, the presence of which may be configured via RRC configuration.

In some implementations, in case of sDCI mTRP, instead of DCI to indicate sticky sTRP/mTRP mode, e.g. via indicating codepoint mapped to single or two TCIs, the sticky sTRP/mTRP mode may be indicated by other signaling. In a first example, an RRC indicates sticky sTRP/mTRP mode. E.g. if any channel is configured to follow 1st and/or 2nd TCIs, that implies sticky mTRP mode is enabled and 2 active TCIs must be indicated. E.g. if a dedicated flag indicate sTRP mode, then all configured indication on following 1st and/or 2nd TCIs are ignored. In a second example, MAC-CE indicates sticky sTRP/mTRP mode. E.g. if MAC-CE can has codepoint mapped to both 1st and 2nd TCI, 1st TCI only, or 2nd TCI only, e.g. if one of two TCIs mapped to the codepoint has reserved value, it means that TCI is empty/invalid. This implies sticky mTRP mode is enabled with 2 TCIs always indicated. A base station such as a gNB can update each of the 1st and 2nd indicated TCIs separately by indicating the corresponding codepoint, e.g. codepoint mapped to 1st TCI only. This saves the codepoint # compared with activating all TCI combinations. E.g. if MAC-CE only has all codepoints mapped to 1 TCI without TCI order index. This implies sticky sTRP mode is enabled with 1 TCI always indicated. E.g. MAC-CE has a flag explicitly indicating whether sticky sTRP or mTRP mode is enabled. Sticky mTRP mode has each codepoint mapped to 1 or 2 TCIs with corresponding order indexes Sticky sTRP mode has each codepoint mapped to 1 TCI without corresponding order index or ignored.

In some implementations, the UE 104 may not expect the dynamic TCI selection field 660 to be absent when two unified TCI states are configured for or indicated for a component carrier or bandwidth part, or set of component carriers or bandwidth parts in a component carrier list. For example, after the activation time of the indicated TCIs, the UE 104 may expect the dynamic TCI selection field 660 to be present in a received DCI scheduling a transmission. In some implementations, if the dynamic TCI selection field 660 is not present, the UE 104 may apply a default unified TCI state. The default unified TCI state may be determined by RRC configuration or a fixed rule. The RRC configuration of the default rule may be included in a PDSCH configuration information element. Example fixed default rules may be to always use the first indicated TCI or to always use the TCI of the scheduling PDCCH. In some implementations, the default rule may be to use both the first unified TCI and the second unified TCI. That is, the absence of the dynamic TCI selection field 660 may not result in dynamic switch between single TRP and multiple TRP modes. A default rule for using both the first unified TCI and the second unified TCI (e.g., when two TCI states have not been indicated) may use a lowest activated codepoint that supports two TCI states. For instance, a default rule may be applied before the UE receive a DCI indicating a TCI state, for example, after initially accessing the network or after a beam failure recovery.

In some implementations, a PDSCH scheduled by a DCI without the dynamic TCI selection field 660 may follow separate or additional default rules. The default rules for PDSCH may apply when the PDSCH scheduling offset is greater than a time duration for QCL. In a first example, for DCI format 1_1 or 1_2 with no dynamic TCI selection field 660, all indicated TCI states may be applied to the scheduled PDSCH. As another example, there may be separate default rules for DCI format 1_0 with no dynamic TCI selection field 660 based on whether single-frequency network (SFN) transmissions are configured or PDCCH repetition is configured. For a first rule, if the scheduling CORESET is indicated for scheduling SFN transmissions, and SFN transmissions for PDSCH are configured, the 2 TCI states of the scheduling SFN CORESET may be applied to the PDSCH. Otherwise (if SFN transmissions for PDSCH are not configured), the first or second TCI state of the scheduling SFN CORESET may be applied to the PDSCH. For a second rule, if the scheduling CORESETs are configured with PDCCH repetition with two linked search spaces, the UE 104 may select the TCI state of the CORESET with the lowest ID for the PDSCH. For a third rule, if the scheduling CORESET is neither configured for SFN nor PDCCH repetition, the TCI of the scheduling CORESET may be applied to the PDSCH.

In some implementations, in a unified TCI framework extension for S-DCI based MTRP, a DCI field in DCI format 1_1/1_2 that schedules/activates PDSCH reception is used to determine which one or both of the indicated joint/DL TCI states shall be applied to the scheduled/activated PDSCH reception. The presence of the DCI field is configurable by RRC; when the DCI field is not present in DCI format 1_1/1_2, the UE shall apply the default indicated joint/DL TCI state(s) to PDSCH reception.

Technical problems related to a unified TCI framework extension include: Details on the default indicated joint/DL TCI state(s) to PDSCH reception; the DCI field is a new indicator field or an existing field (e.g., the existing TCI field); regardless the DCI field is present or not present, how to apply the indicated joint/DL TCI state(s) to PDSCH reception if the offset between the reception of the DCI format 1_1/1_2 and the corresponding PDSCH reception is less than a threshold; and how to apply the indicated joint/DL TCI state(s) to PDSCH reception scheduled/activated by DCI format 1_0. Above applies for the case where PDSCHs scheduled by the same DCI.

In some implementations, 2 TCIs may be always indicated for mTRP mode, which is signaled either via RRC or MAC-CE, instead of DCI. In some implementations, a UE may support 1 or 2 default beams, which is reported as a UE capability. Based on the report, when the time offset between reception of the DCI and scheduling PDSCH is less than a threshold, UE will have different default beam behavior. If the UE supports 2 default beam will use 2 default beam to receive. If the UE supports 1 default beam will receive from 1 default beam, e.g. from the 1 TRP (i.e., following the configuration of the first indicated beam, while the second indicated beam in this case is not used for reception).

In some implementations, in the mTRP mDCI case, if CORESET is configured to share indicated TCI, the indicated TCI for the same CORESETPoolIndex associated with the CORESET will be applied to both its PDCCH and scheduled/activated PDSCH. Otherwise, the TCIs for PDCCH and PDSCH are determined by the legacy way in mDCI mTRP. PDCCH beam of the CORESET is configured by MAC-CE. PDSCH follows the scheduling PDCCH beam.

In some implementations, a UE may be configured with a TCI associated with a non-serving cell physical cell ID (PCI), which is different from the PCI of the serving cell and configured in a RRC list, e.g. SSB-MTC-AdditionalPCI. When the TCI associated with a non-serving cell PCI is configured as the active TCI for a CORESET, the UE is not required to monitor PDCCH candidates for certain PDCCH cell specific search space (CSS) set, e.g. Type 0/0A/0B/1/1A/2/2A CSS set.

In some implementation, in the mDCI mTRP cases, when the UE is configured with SSB-MTC-AdditionalPCI, CORESETs corresponding to different coresetPoolIndex values can be associated with different PCIs via the indicated joint/DL TCI states, where CORESETs corresponding to one coresetPoolIndex value is associated with the serving cell PCI and CORESETs corresponding to another coresetPoolIndex value can be associated with a PCI different from the serving cell PCI e.g. through additionalPCI in the indicated joint/DL TCI state specific to another coresetPoolIndex value. In some implementation, in the sDCI case, the UE may report its capability whether it

supports the inter-cell beam management case where a TCI state within an active TCI codepoint or an indicated TCI can be associated with a non-serving cell PCI. In some implementations, when the UE supports the inter-cell beam management case, and when 2 indicated TCIs are active for the UE, one indicated TCI shall be associated with the serving cell, while the other indicated TCI can be associated with the non-serving cell PCI.

In some implementation, when the UE is configured to perform beam failure recovery procedure in a serving cell. When UE detects a beam failure event associated with an active indicated TCI, the UE may send a beam failure request to the base station. UE may additionally indicate a replacement beam in the beam failure request. A predefined time after receiving the response to the beam failure request, the UE starts to monitor the PDCCH in all CORESETs, and receives PDSCH and aperiodic CSI-RS using the same antenna port quasi co-location parameters as the ones associated with the replacement beam indicated in the beam failure request. When the RRC list of non-serving cell PCIs is configured at a UE, UE shall not report a replacement beam associated with a non-serving cell PCI.

In some implementations, in the mTRP mDCI case, when two SRS resource sets are configured for codebook (CB) and/or non-codebook (NCB) based transmission, the UE may apply the indicated joint/UL TCI state specific to a coresetPoolIndex value to the SRS resources set for CB/NCB based transmission associated with the same coresetPoolIndex value if the SRS resources set is configured to follow the indicated joint/UL TCI state by the RRC flag followUnifiedTCIState. When a single SRS resource set is configured for CB/NCB based transmission, the base station may indicate which coresetPoolIndex value the UE shall use to select the indicated TCI for the SRS resource. Alternatively, the UE may always assume the single SRS resource for CB/NCB based transmission is always associated with the indicated TCI corresponding to a predetermined coresetPoolIndex value, e.g. coresetPoolIndex 0. Additionally and alternatively, the UE may apply the same indicated TCI to the SRS resource for CB/NCB transmission as the CORESET to schedule the SRS transmission, when the scheduling CORESET is configured to follow one of the indicated TCI.

In some implementations, the UE may report to base station its capabilities of the minimum beam application time in different scenarios. For example, the UE may report different minimum beam application time capabilities for DL reception and UL transmission, respectively. The UE may report different minimum beam application time capabilities for mDCI mTRP case and sDCI mTRP case. Based on the UE capability report, the base station may configure different beam application time for different scenarios at UE. For example, the base station may configure different beam application time values for DL, UL, mTRP mDCI, mTRP sDCI at the UE.

In some implementations, in the sDCI mTRP case, if a CORESET other than a CORESET with index 0 is associated only with user specific search space (USS) sets and/or Type3 -PDCCH CSS sets, the CORESET is configured by RRC to apply the first indicated joint/DL TCI state, the second indicated joint/DL TCI state, or both first and second indicated joint/DL TCI states to PDCCH reception on the CORESET.

In some implementation, in the sDCI mTRP cases, If a CORESET other than a CORESET with index 0 is associated at least with CSS sets other than Type3-PDCCH CSS sets and followUnifiedTCIstate=‘enabled’ is configured for the CORESET, the CORESET is configured by RRC to apply the first indicated joint/DL TCI state, the second indicated joint/DL TCI state, or both first and second indicated joint/DL TCI states to PDCCH reception on the CORESET.

In some implementations, in the sDCI mTRP cases, if a CORESET with index 0 is configured with followUnifiedTCIstate=‘enabled’, and if the CORESET is associated with SS #0 for Type 0/0A/2 CSS sets, the CORESET is configured by RRC to apply the first indicated joint/DL TCI state or the second indicated joint/DL TCI state to PDCCH reception on the CORESET.

In some implementations, in the sDCI mTRP cases, if a CORESET with index 0 is configured with followUnifiedTCIstate=‘enabled’, and if the CORESET is not associated with SS #0 for Type 0/0A/2 CSS sets, the CORESET is configured by RRC to apply the first indicated joint/DL TCI state, the second indicated joint/DL TCI state, or both first and second indicated joint/DL TCI states to PDCCH reception on the CORESET.

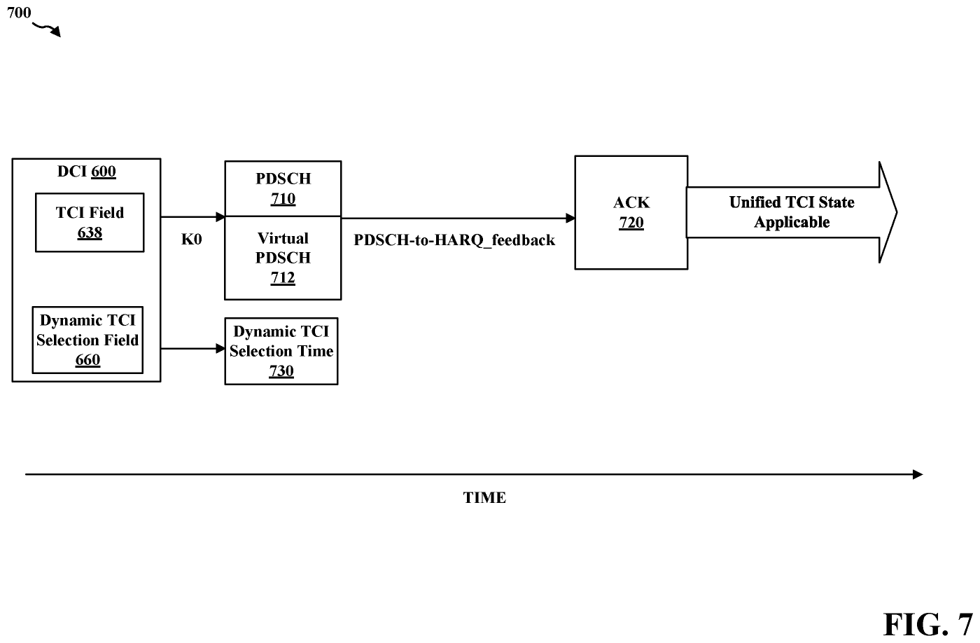

FIG. 7 is a timing diagram 700 illustrating example application times for TCI states. An update to a unified TCI state may become applicable after a DCI 600 including the update is acknowledged. For example, when the DCI 600 includes the TCI field 638, a TDRA field 610 may be used to determine a KO parameter for the PDSCH 710 or a virtual PDSCH 712, in the case that the DCI 600 does not schedule the PDSCH 710 (i.e., no DL assignment). A PDSCH-to-HARQ_feedback timing indicator field 634 may indicate a slot for an ACK 720 to the PDSCH or the DCI 600. The unified TCI state indicated by the TCI field 638 may be applied after the ACK 720.

In an aspect, when the DCI 600 includes the dynamic TCI selection field 660 to dynamically switch applicable TCI states, the UE may not need to wait for the ACK 720. A dynamic TCI selection time 730 may indicate when the indicated TCI state(s) are applicable. For example, the dynamic TCI selection time 730 may be based on a UE capability and/or a RRC configuration. In some implementations, the dynamic TCI selection time 730 may be the same as a timeDurationForQCL parameter. For instance, the application time for the new field should reuse timeDurationForQCL, because this new field is applied to the scheduled PDSCH. Since release 15, timeDurationForQCL has been defined. The UE can obey the DCI beam indication only if the offset >timeDurationForQCL. So there may be no need to clarify the application time just for the dynamic TCI selection time 730, which may be viewed as another DCI beam indication.

If the PDSCH 710 s scheduled before the dynamic TCI selection time 730, the UE 104 may apply a default unified TCI state determined by RRC configuration or the fixed rule to PDSCH reception. Before the application time, the UE buffers data with a default PDSCH beam. The default beams can be determined based on the previously defined rules. In some implementations, the UE 104 may continue to use a previously selected unified TCI state until the dynamic TCI selection time 730. If the PDSCH 710 is scheduled after the dynamic TCI selection time 730, the UE 104 may apply the TCI state indicated by the dynamic TCI selection field. The selected TCI state may be the TCI state indicated in the scheduling DCI, the indicated unified TCI state that is active during the slot of the PDSCH 710, or the indicated unified TCI state that is active during the slot receiving the DCI 600.

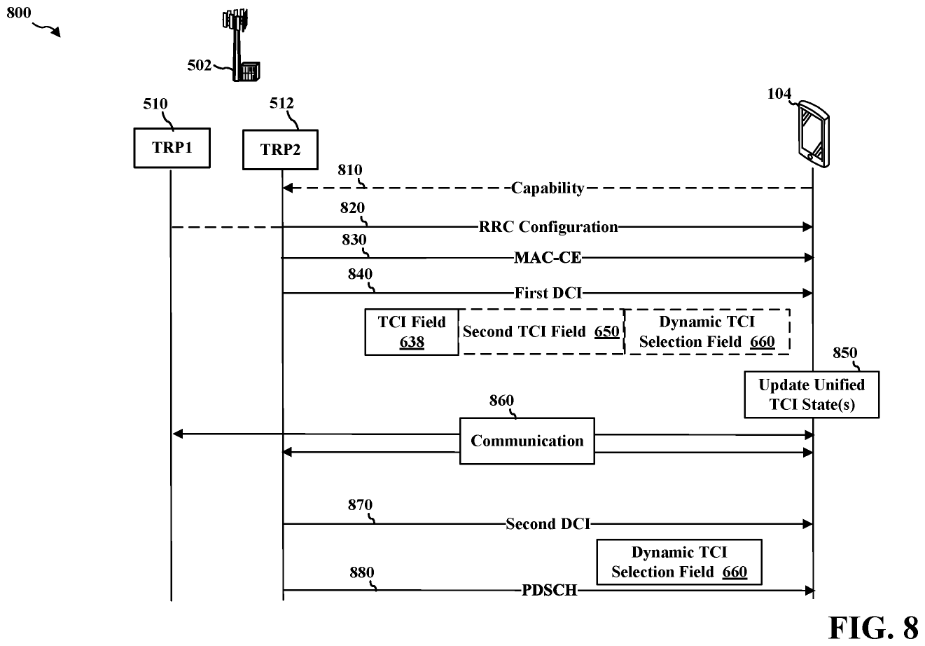

FIG. 8 is a message diagram 800 illustrating various messages for configuration of unified TCI states for two TRPs.

A UE 104 may optionally transmit a capability message 810. The capability message 810 may indicate, for example, a capability to use a default rule for multiple TCIs or a capability indicating a time for changing QCL.

The base station 502 may transmit a RRC configuration 820 via one or both of the TRPs 510, 512. The RRC configuration 820 may configure a plurality of TCI states including unified TCI states. The base station 502 may transmit a MAC-CE 830 via one or both of the TRPs 510, 512. The MAC-CE 830 may downselect the configured TCI states to a set of activated TCI states, each activated TCI state corresponding to a codepoint. In some implementations, the MAC-CE 830 may indicate that two TCI states are associated with a codepoint.

The base station 502 may transmit a first DCI 840 to the UE 104 via one or both of the TRPs 510, 512, for example, based on currently indicated unified TCI state(s) for the PDCCH (e.g., joint or DL). The first DCI 840 may include at least the TCI field 638. In some implementations, the TCI field 638 may be applicable to both TRPs 510, 512. For example, the TCI field 638 may indicate a codepoint associated with two TCI states. In other implementations, the TCI field 638 may indicate a single TCI state. In some implementations, the DCI 840 may include the second TCI field 650, which indicates a second codepoint for a second activated TCI state. Accordingly, the UE 104 may determine two TCI states when the first DCI 840 includes the TCI field 638 and the second TCI field 650. In some implementations, the first DCI 840 includes the dynamic TCI selection field 660, which specifies whether the TCI field 638 applies to the first unified TCI state corresponding to the first TRP 510 or the second unified TCI state corresponding to the second TRP 512. Accordingly, the UE 104 may determine to which of the unified TCI states the TCI field 638 indicating a single TCI state corresponds.

At block 850, the UE 104 may update unified TCI states based on the first DCI 840. For example, where the first DCI 840 indicates two TCI states, the UE 104 may update each of the unified TCI state to an updated TCI state with the corresponding TCI information indicated by the first DCI 840 (e.g., update the configured values). In some implementations, where the first DCI 840 indicates a single TCI state, the UE 104 may update the unified TCI state indicated by the dynamic TCI selection field 660 without updating the other unified TCI state.

The base station 502 and the UE 104 may exchange communications 860 based on the unified TCI states. For example, the communications 860 may include PDSCH, PDCCH, PUSCH, and PUCCH, and may optionally include the reference signals that can be indicated by unified TCI states. Accordingly, the base station 502 and the UE 104 may communicate according to the updated unified TCI states.

In an aspect, the base station 502 may transmit a second DCI 870 to the UE 104. The second DCI 870 may indicate a TRP to use for PDSCH. For example, the second DCI 870 may include the dynamic TCI selection field 660. For instance, the dynamic TCI selection field 660 of the second DCI 870 may indicate only the second TRP 512. The UE 104 may switch to a single TRP mode using the second TRP 512 for receiving the PDSCH 880 even though a unified TCI state is configured for the first TRP 510. In some implementations, the base station 502 may transmit a subsequent DCI with the dynamic TCI selection field 660 to switch to the first TRP 510 or indicate both TRPs. In some implementations, the dynamic TCI selection field 660 of the second DCI 870 may apply to only the PDSCH 880 scheduled by the second DCI 870.

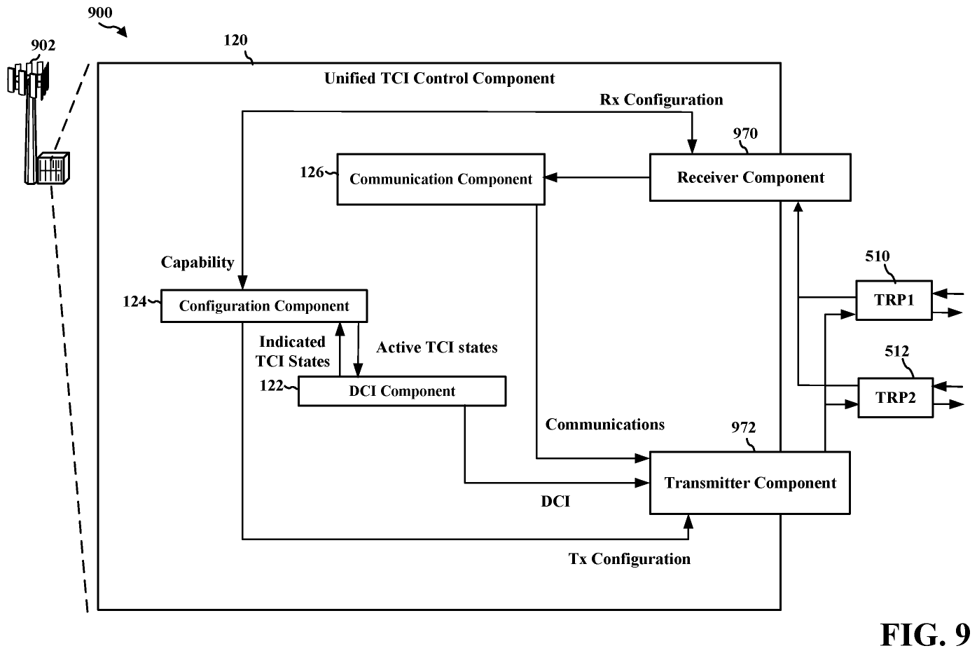

FIG. 9 is a conceptual data flow diagram 900 illustrating the data flow between different means/components in an example base station 902, which may be an example of the base station 102 including the unified TCI control component 120. The unified TCI control component 120 may be implemented by the memory 376 and the TX processor 316, the RX processor 370, and/or the controller/processor 375 of FIG. 3. For example, the memory 376 may store executable instructions defining the unified TCI control component 120 and the TX processor 316, the RX processor 370, and/or the controller/processor 375 may execute the instructions.

The base station 102 may include a receiver component 970, which may include, for example, a radio frequency (RF) receiver for receiving the signals described herein. The base station 102 may include a transmitter component 972, which may include, for example, an RF transmitter for transmitting the signals described herein. In an aspect, the receiver component 970 and the transmitter component 972 may be co-located in a transceiver such as illustrated by the TX/RX 318 in FIG. 3. Further, the receiver component 970 and the transmitter component 972 may each communicate via the first TRP 510 and the second TRP 512.

As discussed with respect to FIG. 1, the unified TCI control component 120 may include the DCI component 122, the configuration component 124, and the communication component 126.

The receiver component 970 may receive UL signals from the UE 104 including UL communications such as the capability message 810 and the communications 860 (e.g., PUSCH and PUCCH). The receiver component 970 may provide the capability message 810 to the configuration component 124. The receiver component 970 may provide the communications to the communication component 126.

The configuration component 124 is configured to update a configuration of the UE for at least one of the first unified TCI state to a first updated unified TCI state or the second unified TCI state to a second updated unified TCI state based on the at least one TCI field. For example, the configuration component 124 may obtain the capability message 810 from the UE 104 via the receiver component 970. The configuration component 124 may determine potential TCI states for the UE 104 to communicate with the base station 902 via the TRPs 510 and 512. The configuration component 124 may output the RRC configuration 820 and the MAC-CE 830 for transmission to the UE 104 via the transmitter component 972. The configuration component 124 may also output the active TCI states to the DCI component 122. The configuration component 124 may receive the indicated TCI states from the DCI component 122. The configuration component 124 may update the receiver component 970 with a Rx configuration and the transmitter component 972 with a Tx configuration. The Rx configuration and the Tx configuration may be based on the updated unified TCI states for the UE 104.

The DCI component 122 may be configured to transmit a single DCI (e.g., first DCI 840) to the UE 104 that is configured with a first unified TCI state for a first TRP and second unified TCI state for a second TRP. The first DCI 840 includes at least a first TCI field 638. The DCI component 122 may obtain the active TCI states from the configuration component 124. The DCI component 122 may select an active TCI state, for example, based on channel state information (CSI) received from the UE 104. The DCI component 122 may generate the first DCI 840 to include at least the first TCI field 638. The DCI component 122 may additionally include the second TCI field 650 or the dynamic TCI selection field 660 depending on the TCI states to use. The DCI component 122 may output the first DCI 840 for transmission via the transmitter component 972. In some implementations, the DCI component 122 is further configured to generate the second DCI 870 including the dynamic TCI selection field 660. For instance, the DCI component 122 may schedule the PDSCH 880 with the second DCI 870. The dynamic TCI selection field 660 indicates whether the first unified TCI state or the second unified TCI state is applicable to reception of the PDSCH 880 starting from an application time (e.g., dynamic TCI selection time) 730 after the second DCI 870. The DCI component 122 may output the second DCI 870 for transmission via the transmitter component 972.

The communication component 126 that is configured to communicate with the UE via at least one of the first TRP or the second TRP based on the first updated unified TCI state or the second updated unified TCI state. For example, the communication component 126 may receive the UL communications 860 (e.g., PUSCH and PUCCH) via the receiver component 970 and transmit the DL communications 860 (e.g., PDSCH and PDCCH) via the transmitter component 972. In such implementations, the communication component 126 is configured to transmit the PDSCH after the application time via at least one of the first TRP or the second TRP based on the first unified TCI state or the second unified TCI state as indicated by the dynamic TCI selection field 660.

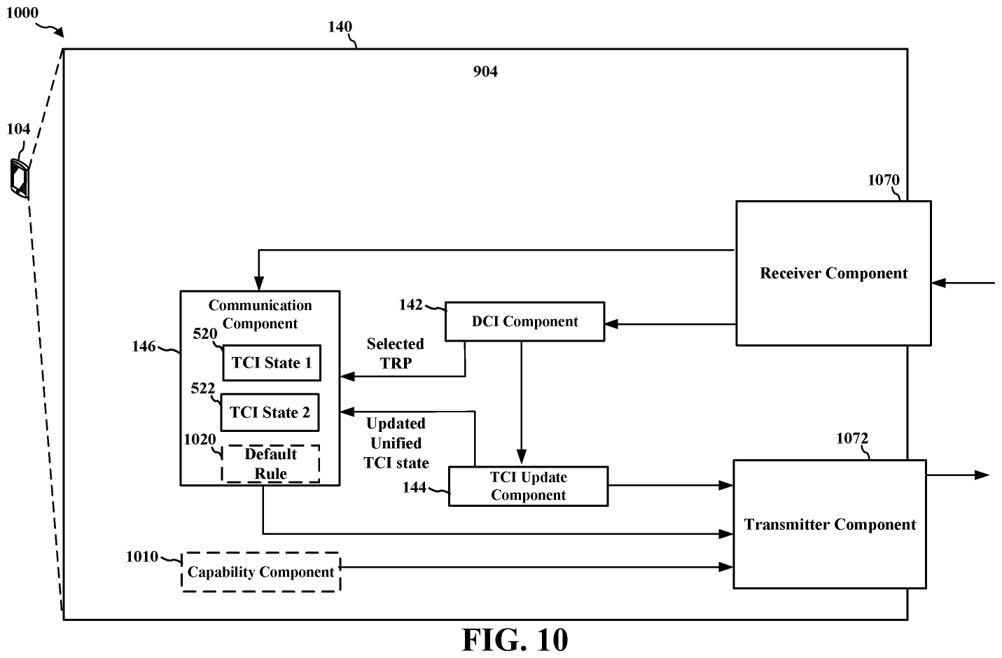

FIG. 10 is a conceptual data flow diagram 1000 illustrating the data flow between different means/components in an example UE 104, which may be an example of the UE 104 (FIG. 1) and include the unified TCI component 140. The unified TCI component 140 may be implemented by the memory 360 and the TX processor 368, the RX processor 356, and/or the controller/processor 359. For example, the memory 360 may store executable instructions defining the unified TCI component 140 and the TX processor 368, the RX processor 356, and/or the controller/processor 359 may execute the instructions.

The UE 104 may include a receiver component 1070, which may include, for example, a RF receiver for receiving the signals described herein. The UE 104 may include a transmitter component 1072, which may include, for example, an RF transmitter for transmitting the signals described herein. In an aspect, the receiver component 1070 and the transmitter component 1072 may co-located in a transceiver such as the TX/RX 352 in FIG. 3.

As discussed with respect to FIG. 1, the unified TCI component 140 may include the DCI component 142, the TCI update component 144, and the communication component 146. The unified TCI component 140 may optionally include a capability component 1010.

The receiver component 1070 may receive DL signals described herein such as the RRC configuration 820, the MAC-CE 830, the first DCI 840, the communications 860, the second DCI 870, and the PDSCH 880. The receiver component 1070 may provide the RRC configuration 820, the MAC-CE 830, the first DCI 840, and the second DCI 870 to the DCI component 142. The receiver component 1070 may provide the communications 860 and the PDSCH 880 to the communication component 146.

The DCI component 142 is configured to receive a single DCI for the UE 904 that is configured with a first unified TCI state (e.g., first TCI state 520) for a first TRP 510 and second unified TCI state (e.g., TCI state 522) for a second TRP 512. For example, the DCI component 142 may receive one of the first DCI 840 or the second DCI 870 from the base station 102 via the receiver component 1070. The DCI includes at least a first TCI field 638. In some implementations, the DCI includes the second TCI field 650 or the dynamic TCI selection field 660. The DCI component 142 may output the fields of the TCI-related fields of the first DCI 840 or the second DCI 870 to the TCI update component 144.

The TCI update component 144 is configured to update a configuration of at least one of the first unified TCI state 520 to a first updated unified TCI state or the second unified TCI state 522 to a second updated unified TCI state based on the at least one TCI field. For example, the TCI update component 144 may obtain the TCI field 638, the second TCI field 650, and/or the dynamic TCI selection field 660 from the DCI component 142. The TCI update component 144 may determine how many TCI states are indicated and to which configured unified TCI states 520, 522 the indicated TCI states are applicable. For example, when two TCI states are indicated, either by the TCI field 638 or the combination of the TCI field 638 and the second TCI field 650, the TCI update component 144 may update both the unified TCI states 520 and 522. When only a single TCI state is indicated by the TCI field 638, the TCI update component 144 may use the dynamic TCI selection field 660 or a default rule to determine which unified TCI state 520, 522 is being updated. The TCI update component 144 may output the updated unified TCI states to the communication component 146.

The communication component 146 is configured to communicate with at least one of the first TRP 510 or the second TRP 512 based on the first updated unified TCI state 520 or the second updated unified TCI state 522. For example, the communication component 146 may receive the DL communications 860 via the receiver component 1070 and transmit the UL communications 860 via the transmitter component 1072. The communication component 146 may use the unified TCI state 520 and/or the unified TCI state 522 for the communications 860. For example, the communication component 146 may indicate the unified TCI states 520, 522 to configure the receiver component 1070 or the transmitter component 1072 (e.g., with the correct beam). In some implementations, where the unified TCI states 520, 522 have not been indicated, the communication component 146 may communicate according to a default rule 1020. In some implementations, the communication component 146 may obtain a selected TRP for a PDSCH 880 from the DCI component 142. The communication component 146 is configured to receive the PDSCH reception after the application time (e.g., dynamic TCI selection time 730) with at least one of the first TRP or the second TRP based on the first unified TCI state or the second unified TCI state corresponding to the selected TRP.

The capability component 1010 may be configured to transmit an indication of a capability of the UE to support the default rule. For example, the capability component 1010 may output the capability message 810 for transmission to the base station 102 via the transmitter component 1072.

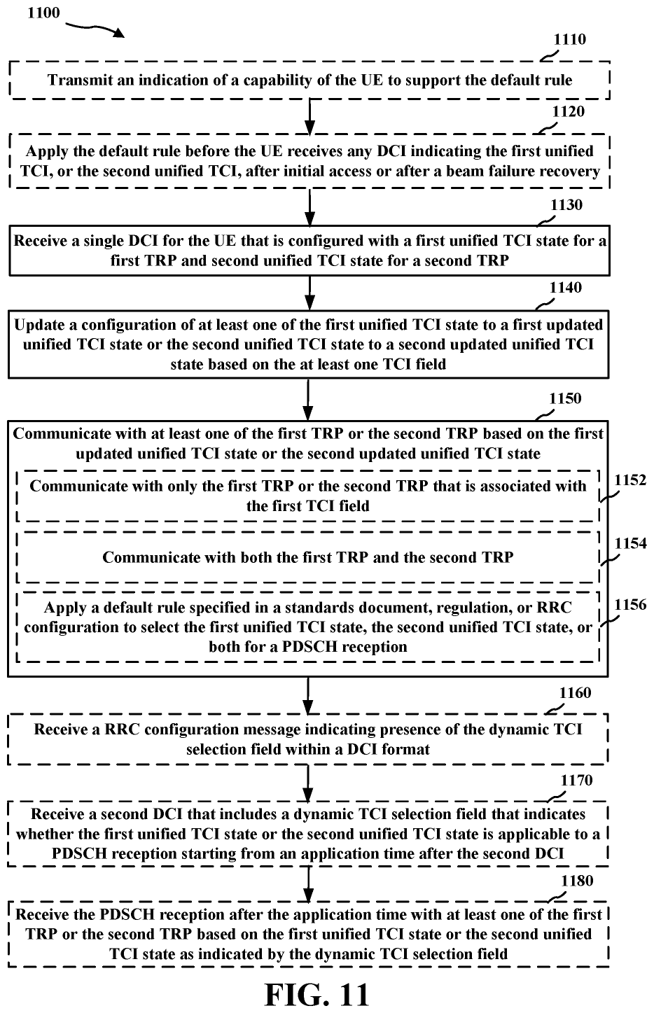

FIG. 11 is a flowchart of an example method 1100 for a UE to communicate with a base station having two TRPs based on a single DCI. The method 1100 may be performed by a UE (such as the UE 104, which may include the memory 360 and which may be the entire UE 104 or a component of the UE 104 such as the unified TCI component 140, TX processor 368, the RX processor 356, or the controller/processor 359). The method 1100 may be performed by the unified TCI component 140 in communication with the unified TCI control component 120 of the base station 102. Optional blocks are shown with dashed lines.

At block 1110, the method 1100 may optionally include transmitting an indication of a capability of the UE to support the default rule. In some implementations, for example, the UE 104, the TX processor 368, or the controller/processor 359 may execute the unified TCI component 140 or the capability component 1010 to transmit the indication of a capability (e.g., capability message 810) of the UE to support the default rule 1020. Accordingly, the UE 104, the TX processor 368, or the controller/processor 359 executing the unified TCI component 140 or the capability component 1010 may provide means for transmitting an indication of a capability of the UE to support the default rule.

At block 1120, the method 1100 may optionally include applying the default rule before the UE receives any DCI indicating the first unified TCI or the second unified TCI, after initial access or after a beam failure recovery. In some implementations, for example, the UE 104, the RX processor 356 or the controller/processor 359 may execute the unified TCI component 140 or the communication component 146 to apply the default rule before the UE receives any DCI indicating the first unified TCI or the second unified TCI, after initial access, or after a beam failure recovery. Accordingly, the UE 104, the RX processor 356, or the controller/processor 359 executing the unified TCI component 140 or the communication component 146 may provide means for applying the default rule before the UE receives any DCI indicating the first unified TCI or the second unified TCI, after initial access, or after a beam failure recovery.

At block 1130, the method 1100 includes receiving a single DCI for the UE that is configured with a first unified TCI state for a first TRP and second unified TCI state for a second TRP. In some implementations, for example, the UE 104, the RX processor 356 or the controller/processor 359 may execute the unified TCI component 140 or the DCI component 142 to receive the single DCI for the UE that is configured with a first unified TCI state for a first TRP and second unified TCI state for a second TRP. In some implementations, the first unified TCI state or the second unified TCI state is applicable to both a control channel and a shared channel in an uplink direction, a downlink direction, or both the uplink direction and the downlink direction. Accordingly, the UE 104, the RX processor 356, or the controller/processor 359 executing the unified TCI component 140 or DCI component 142 may provide means for receiving a single DCI for the UE that is configured with a first unified TCI state for a first TRP and second unified TCI state for a second TRP.

At block 1140, the method 1100 includes updating a configuration of at least one of the first unified TCI state to a first updated unified TCI state or the second unified TCI state to a second updated unified TCI state based on the at least one TCI field. In some implementations, for example, the UE 104, the RX processor 356, the TX processor 368, or the controller/processor 359 may execute the unified TCI component 140 or the TCI update component 144 to update a configuration of at least one of the first unified TCI state to a first updated unified TCI state or the second unified TCI state to a second updated unified TCI state based on the at least one TCI field. In some implementations, the first TCI field is applicable to both the first TRP and the second TRP. In some implementations, where the single DCI further includes a second TCI field that is applicable to the second TRP, the block 1140 may include updating a configuration of the second TRP to the second updated unified TCI state based on the second TCI field. In some implementations, the first TCI field is applicable to one of the first TRP or the second TRP. The single DCI may further include a second field that associates the first TCI field to the one of the first TRP or the second TRP. In such implementations, updating the configuration may include updating only the first TCI state or the second TCI state associated with the first TCI field. Accordingly, the UE 104, the RX processor 356, the TX processor 368, or the controller/processor 359 executing the unified TCI component 140 or TCI update component 144 may provide means for updating a configuration of at least one of the first unified TCI state to a first updated unified TCI state or the second unified TCI state to a second updated unified TCI state based on the at least one TCI field.

At block 1150, the method 1100 includes communicating with at least one of the first TRP or the second TRP based on the first updated unified TCI state or the second updated unified TCI state. In some implementations, for example, the UE 104, the RX processor 356, the TX processor 368, or the controller/processor 359 may execute the unified TCI component 140 or the communication component 146 to communicate with at least one of the first TRP or the second TRP based on the first updated unified TCI state or the second updated unified TCI state. In some implementations, at sub-block 1152, the block 1150 may optionally include communicating with only the first TRP or the second TRP that is associated with the first TCI field. In some implementations, at sub-block 1154, the block 1150 may optionally include communicating with both the first TRP and the second TRP. In some implementations, at sub-block 1156, the block 1150 may optionally include applying a default rule specified in a standards document, regulation, or RRC configuration to select the first updated unified TCI state, the second updated unified TCI state, or both for a PDSCH reception. The default rule may indicate selecting both the first updated unified TCI state and the second updated unified TCI state in an absence of an indication of a single TCI state for the PDSCH reception. For instance, the default rule may indicate selection of a configured and activated codepoint with a lowest index value that is associated with two unified TCI states. Accordingly, the UE 104, the RX processor 356, the TX processor 368, or the controller/processor 359 executing the unified TCI component 140 or the communication component 146 may provide means for communicating with at least one of the first TRP or the second TRP based on the first updated unified TCI state or the second updated unified TCI state.

At block 1160, the method 1100 may optionally include receiving a RRC configuration message indicating presence of the dynamic TCI selection field within a DCI format. In some implementations, for example, the UE 104, the RX processor 356 or the controller/processor 359 may execute the unified TCI component 140 or the TCI update component 144 to receive a RRC configuration message indicating presence of the dynamic TCI selection field within a DCI format. Accordingly, the UE 104, the RX processor 356, or the controller/processor 359 executing the unified TCI component 140 or the TCI update component 144 may provide means for receiving a RRC configuration message indicating presence of the dynamic TCI selection field within a DCI format.

At block 1170, the method 1100 may optionally include receiving a second DCI that includes a dynamic TCI selection field that indicates whether the first unified TCI state or the second unified TCI state is applicable to a PDSCH reception starting from an application time after the second DCI. In some implementations, for example, the UE 104, the RX processor 356 or the controller/processor 359 may execute the unified TCI component 140 or the DCI component 142 to receive a second DCI that includes a dynamic TCI selection field that indicates whether the first unified TCI state or the second unified TCI state is applicable to a PDSCH reception starting from an application time after the second DCI. In some implementations, the dynamic TCI selection field is applicable to any PDSCH reception associated with the first unified TCI state or the second unified TCI state after the application time until another TCI selection field is received. In such implementations, the second DCI may not include a downlink assignment for a PDSCH reception. In some implementations, the dynamic TCI selection field is applicable to only a PDSCH reception scheduled by the second DCI. In some implementations, the application time is based on a capability (e.g., capability message 810) of the UE. In some implementations, the application time is based on a configured time duration for QCL parameter. Accordingly, the UE 104, the RX processor 356, or the controller/processor 359 executing the unified TCI component 140 or DCI component 142 may provide means for receiving a second DCI that includes a dynamic TCI selection field that indicates whether the first unified TCI state or the second unified TCI state is applicable to a PDSCH reception starting from an application time after the second DCI.

At block 1180, the method 1100 may optionally include receiving the PDSCH reception after the application time with at least one of the first TRP or the second TRP based on the first unified TCI state or the second unified TCI state as indicated by the dynamic TCI selection field. In some implementations, for example, the UE 104, the RX processor 356 or the controller/processor 359 may execute the unified TCI component 140 or the communication component 146 to receive the PDSCH reception after the application time with at least one of the first TRP or the second TRP based on the first unified TCI state or the second unified TCI state as indicated by the dynamic TCI selection field. Accordingly, the UE 104, the RX processor 356, or the controller/processor 359 executing the unified TCI component 140 or communication component 146 may provide means for receiving the PDSCH reception after the application time with at least one of the first TRP or the second TRP based on the first unified TCI state or the second unified TCI state as indicated by the dynamic TCI selection field.

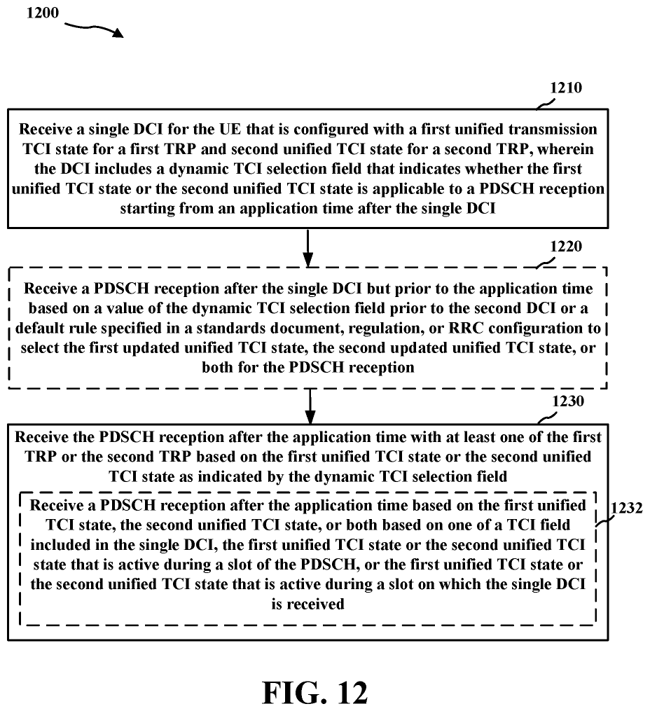

FIG. 12 is a flowchart of another example method 1200 for a UE to communicate with a base station having two TRPs based on a single DCI. The method 1200 may be performed by a UE (such as the UE 104, which may include the memory 360 and which may be the entire UE 104 or a component of the UE 104 such as the unified TCI component 140, TX processor 368, the RX processor 356, or the controller/processor 359). The method 1200 may be performed by the unified TCI component 140 in communication with the unified TCI control component 120 of the base station 102. The method 1200 may be performed in conjunction with the method 1100 or performed separately. In some implementations, the block 1210 may correspond to block 1170 and the block 1230 may correspond to the block 1180. Further, any of the blocks of the method 1100 may be performed with the method 1200. Optional blocks are shown with dashed lines.

At block 1210, the method 1200 includes receiving a single DCI for the UE that is configured with a first unified transmission TCI state for a first TRP and second unified TCI state for a second TRP, wherein the DCI includes a dynamic TCI selection field that indicates whether the first unified TCI state or the second unified TCI state is applicable to a PDSCH reception starting from an application time after the single DCI. In some implementations, for example, the UE 104, the RX processor 356 or the controller/processor 359 may execute the unified TCI component 140 or the DCI component 142 to receive the single DCI for the UE that is configured with a first unified transmission TCI state for a first TRP and second unified TCI state for a second TRP, wherein the DCI includes a dynamic TCI selection field that indicates whether the first unified TCI state or the second unified TCI state is applicable to a PDSCH reception starting from an application time after the single DCI. Accordingly, the UE 104, the RX processor 356, or the controller/processor 359 executing the unified TCI component 140 or DCI component 142 may provide means for receiving a single DCI for the UE that is configured with a first unified transmission TCI state for a first TRP and second unified TCI state for a second TRP, wherein the DCI includes a dynamic TCI selection field that indicates whether the first unified TCI state or the second unified TCI state is applicable to a PDSCH reception starting from an application time after the single DCI.

At block 1220, the method 1200 may optionally include receiving a PDSCH reception after the single DCI but prior to the application time based on a value of the dynamic TCI selection field prior to the second DCI or a default rule specified in a standards document, regulation, or RRC configuration to select the first updated unified TCI state, the second updated unified TCI state, or both for the PDSCH reception. In some implementations, for example, the UE 104, the RX processor 356 or the controller/processor 359 may execute the unified TCI component 140 or the DCI component 142 to receive the PDSCH reception after the single DCI but prior to the application time based on a value of the dynamic TCI selection field prior to the second DCI or a default rule specified in a standards document, regulation, or RRC configuration to select the first updated unified TCI state, the second updated unified TCI state, or both for the PDSCH reception. Accordingly, the UE 104, the RX processor 356, or the controller/processor 359 executing the unified TCI component 140 or DCI component 142 may provide means for receiving a PDSCH reception after the single DCI but prior to the application time based on a value of the dynamic TCI selection field prior to the second DCI or a default rule specified in a standards document, regulation, or RRC configuration to select the first updated unified TCI state, the second updated unified TCI state, or both for the PDSCH reception.

At block 1230, the method 1200 includes receiving the PDSCH reception after the application time with at least one of the first TRP or the second TRP based on the first unified TCI state or the second unified TCI state as indicated by the dynamic TCI selection field. In some implementations, for example, the UE 104, the RX processor 356 or the controller/processor 359 may execute the unified TCI component 140 or the DCI component 142 to receive the PDSCH reception after the application time with at least one of the first TRP or the second TRP based on the first unified TCI state or the second unified TCI state as indicated by the dynamic TCI selection field. In some implementations, at sub-block 1232, the block 1230 may optionally include receiving a

PDSCH reception after the application time based on the first unified TCI state, the second unified TCI state, or both based on one of a TCI field included in the single DCI, the first unified TCI state or the second unified TCI state that is active during a slot of the PDSCH, or the first unified TCI state or the second unified TCI state that is active during a slot on which the single DCI is received. Accordingly, the UE 104, the RX processor 356, or the controller/processor 359 executing the unified TCI component 140 or DCI component 142 may provide means for receiving the PDSCH reception after the application time with at least one of the first TRP or the second TRP based on the first unified TCI state or the second unified TCI state as indicated by the dynamic TCI selection field.

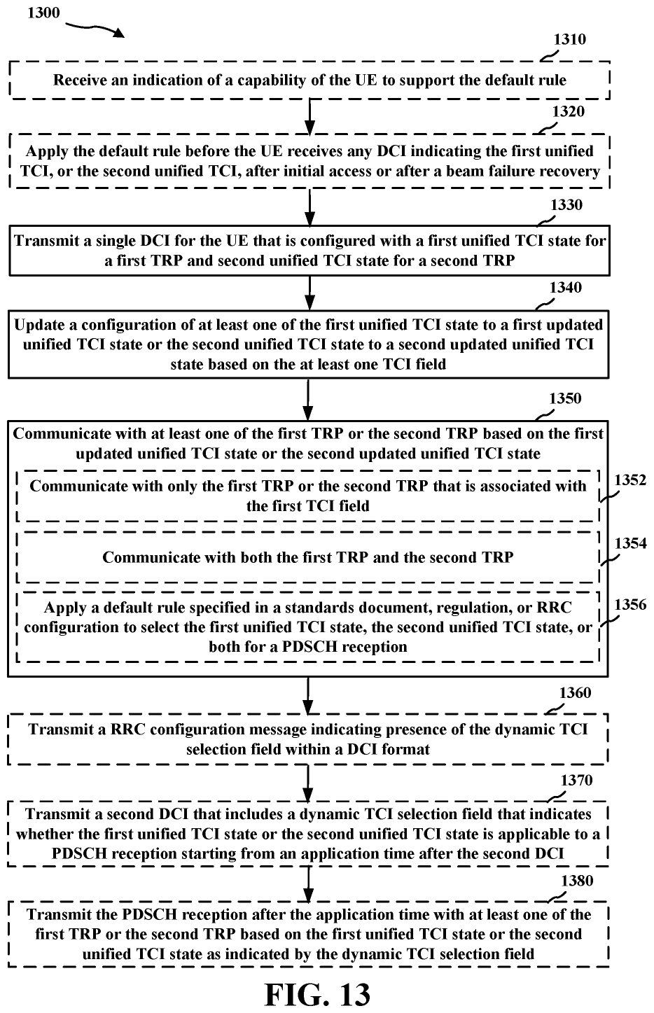

FIG. 13 is a flowchart of an example method 1300 for a network node to communicate with a UE via two TRPs based on a single TRP. The method 1300 may be performed by a network node (such as the base station 102, which may include the memory 376 and which may be the entire base station 102 or a component of the base station 102 such as the unified TCI control component 120, the TX processor 316, the RX processor 370, or the controller/processor 375). The method 1300 may be performed by the unified TCI control component 120 in communication with the unified TCI component 140 of the UE 104.

At block 1310, the method 1300 may optionally include receiving an indication of a capability of the UE to support the default rule. In some implementations, for example, base station 102, the RX processor 370, or the controller/processor 375 may execute the unified TCI control component 120 or the configuration component 124 to Receive an indication of a capability of the UE to support the default rule. Accordingly, the base station 102, the RX processor 370, or the controller/processor 375 executing the unified TCI control component 120 or the configuration component 124 may provide means for receiving an indication of a capability of the UE to support the default rule.

At block 1320, the method 1300 may optionally include applying the default rule before the UE receives any DCI indicating the first unified TCI, or the second unified TCI, after initial access or after a beam failure recovery. In some implementations, for example, the base station 102, the TX processor 316, or the controller/processor 375 may execute the unified TCI control component 120 or the communication component 126 to apply the default rule before the UE receives any DCI indicating the first unified TCI, or the second unified TCI, after initial access or after a beam failure recovery. Accordingly, the base station 102, the TX processor 316, or the controller/processor 375 executing the unified TCI control component 120 or the communication component 126 may provide means for applying the default rule before the UE receives any DCI indicating the first unified TCI, or the second unified TCI, after initial access or after a beam failure recovery.

At block 1330, the method 1300 includes transmitting a single DCI for the UE that is configured with a first unified TCI state for a first TRP and second unified TCI state for a second TRP. In some implementations, for example, the base station 102, the TX processor 316, or the controller/processor 375 may execute the unified TCI control component 120 or the DCI component 122 to transmit a single DCI for the UE that is configured with a first unified TCI state for a first TRP and second unified TCI state for a second TRP. In some implementations, the first unified TCI state or the second unified TCI state is applicable to both a control channel and a shared channel in an uplink direction, a downlink direction, or both the uplink direction and the downlink direction. Accordingly, the base station 102, the TX processor 316, or the controller/processor 375 executing the unified TCI control component 120 or the DCI component 122 may provide means for transmitting a single DCI for the UE that is configured with a first unified TCI state for a first TRP and second unified TCI state for a second TRP.

At block 1340, the method 1300 includes updating a configuration of at least one of the first unified TCI state to a first updated unified TCI state or the second unified TCI state to a second updated unified TCI state based on the at least one TCI field. In some implementations, for example, the base station 102, the TX processor 316, or the controller/processor 375 may execute the unified TCI control component 120 or the configuration component 124 to update a configuration of at least one of the first unified TCI state to a first updated unified TCI state or the second unified TCI state to a second updated unified TCI state based on the at least one TCI field. In some implementations, the first TCI field is applicable to both the first TRP and the second TRP. In some implementations, where the single DCI further includes a second TCI field that is applicable to the second TRP, the block 1140 may include updating a configuration of the second TRP to the second updated unified TCI state based on the second TCI field. In some implementations, the first TCI field is applicable to one of the first TRP or the second TRP. The single DCI may further include a second field that associates the first TCI field to the one of the first TRP or the second TRP. In such implementations, updating the configuration may include updating only the first TCI state or the second TCI state associated with the first TCI field. Accordingly, the base station 102, the TX processor 316, or the controller/processor 375 executing the unified TCI control component 120 or the DCI component 122 may provide means for updating a configuration of at least one of the first unified TCI state to a first updated unified TCI state or the second unified TCI state to a second updated unified TCI state based on the at least one TCI field.

At block 1350, the method 1300 includes communicating with at least one of the first TRP or the second TRP based on the first updated unified TCI state or the second updated unified TCI state. In some implementations, for example, the base station 102, the TX processor 316, or the controller/processor 375 may execute the unified TCI control component 120 or the communication component 126 to communicate with at least one of the first TRP or the second TRP based on the first updated unified TCI state or the second updated unified TCI state. In some implementations, at sub-block 1352, the block 1150 may optionally include communicating with only the first TRP or the second TRP that is associated with the first TCI field. In some implementations, at sub-block 1354, the block 1150 may optionally include communicating with both the first TRP and the second TRP. In some implementations, at sub-block 1356, the block 1150 may optionally include applying a default rule specified in a standards document, regulation, or RRC configuration to select the first updated unified TCI state, the second updated unified TCI state, or both for a PDSCH reception. The default rule may indicate selecting both the first updated unified TCI state and the second updated unified TCI state in an absence of an indication of a single TCI state for the PDSCH reception. For instance, the default rule may indicate selection of a configured and activated codepoint with a lowest index value that is associated with two unified TCI states. Accordingly, the base station 102, the TX processor 316, or the controller/processor 375 executing the unified TCI control component 120 or the DCI component 122 may provide means communicating with at least one of the first TRP or the second TRP based on the first updated unified TCI state or the second updated unified TCI state.

At block 1360, the method 1300 may optionally include transmitting a RRC configuration message indicating presence of the dynamic TCI selection field within a DCI format. In some implementations, for example, the base station 102, the TX processor 316, or the controller/processor 375 may execute the unified TCI control component 120 or the configuration component 124 to transmit a RRC configuration message indicating presence of the dynamic TCI selection field within a DCI format. Accordingly, the base station 102, the TX processor 316, or the controller/processor 375 executing the unified TCI control component 120 or the configuration component 124 may provide means for transmitting a RRC configuration message indicating presence of the dynamic TCI selection field within a DCI format.

At block 1370, the method 1300 may optionally include transmitting a second DCI that includes a dynamic TCI selection field that indicates whether the first unified TCI state or the second unified TCI state is applicable to a PDSCH reception starting from an application time after the second DCI. In some implementations, for example, the base station 102, the TX processor 316, or the controller/processor 375 may execute the unified TCI control component 120 or the DCI component 122 to transmit a second DCI that includes a dynamic TCI selection field that indicates whether the first unified TCI state or the second unified TCI state is applicable to a PDSCH reception starting from an application time after the second DCI. In some implementations, the dynamic TCI selection field is applicable to any PDSCH reception associated with the first unified TCI state or the second unified TCI state after the application time until another TCI selection field is received. In such implementations, the second DCI may not include a downlink assignment for a PDSCH reception. In some implementations, the dynamic TCI selection field is applicable to only a PDSCH reception scheduled by the second DCI. In some implementations, the application time is based on a capability (e.g., capability message 810) of the UE. In some implementations, the application time is based on a configured time duration for QCL parameter. Accordingly, the base station 102, the TX processor 316, or the controller/processor 375 executing the unified TCI control component 120 or the DCI component 122 may provide means for transmitting a second DCI that includes a dynamic TCI selection field that indicates whether the first unified TCI state or the second unified TCI state is applicable to a PDSCH reception starting from an application time after the second DCI.

At block 1380, the method 1300 may optionally include transmitting the PDSCH reception after the application time with at least one of the first TRP or the second TRP based on the first unified TCI state or the second unified TCI state as indicated by the dynamic TCI selection field. In some implementations, for example, the base station 102, the TX processor 316, or the controller/processor 375 may execute the unified TCI control component 120 or the communication component 126 to transmit the PDSCH reception after the application time with at least one of the first TRP or the second TRP based on the first unified TCI state or the second unified TCI state as indicated by the dynamic TCI selection field. Accordingly, the base station 102, the TX processor 316, or the controller/processor 375 executing the unified TCI control component 120 or the communication component 126 may provide means for transmitting the PDSCH reception after the application time with at least one of the first TRP or the second TRP based on the first unified TCI state or the second unified TCI state as indicated by the dynamic TCI selection field.

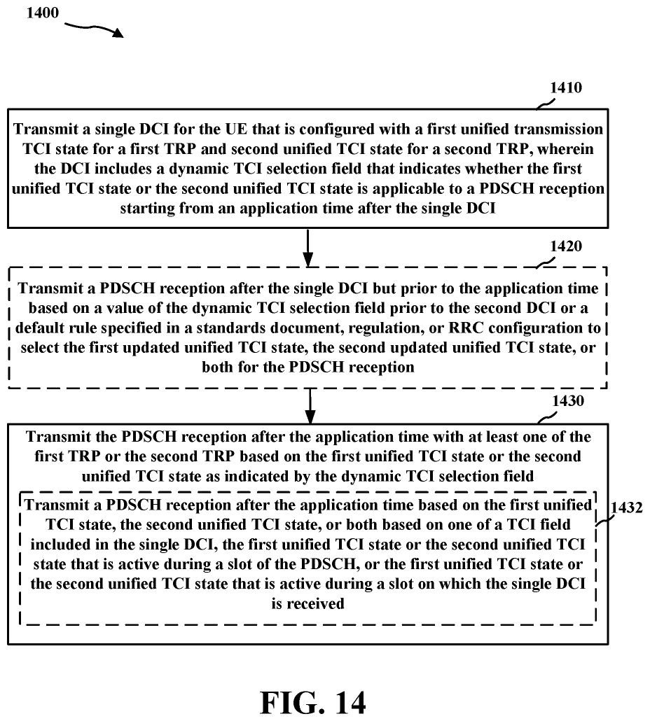

FIG. 14 is a flowchart of an example method 1400 for a network node to communicate with a UE via two TRPs based on a single TRP. The method 1400 may be performed by a network node (such as the base station 102, which may include the memory 376 and which may be the entire base station 102 or a component of the base station 102 such as the unified TCI control component 120, the TX processor 316, the RX processor 370, or the controller/processor 375). The method 1400 may be performed by the unified TCI control component 120 in communication with the unified TCI component 140 of the UE 104. The method 1400 may be performed in conjunction with the method 1300 or performed separately. In some implementations, the block 1410 may correspond to block 1370 and the block 1430 may correspond to the block 1380. Further, any of the blocks of the method 1300 may be performed with the method 1400. Optional blocks are shown with dashed lines.

At block 1410, the method 1400 includes transmitting a single DCI for the UE that is configured with a first unified transmission TCI state for a first TRP and second unified TCI state for a second TRP, wherein the DCI includes a dynamic TCI selection field that indicates whether the first unified TCI state or the second unified TCI state is applicable to a PDSCH reception starting from an application time after the single DCI. In some implementations, for example, the base station 102, the TX processor 316, or the controller/processor 375 may execute the unified TCI control component 120 or the DCI component 122 to transmit a single DCI for the UE that is configured with a first unified transmission TCI state for a first TRP and second unified TCI state for a second TRP, wherein the DCI includes a dynamic TCI selection field that indicates whether the first unified TCI state or the second unified TCI state is applicable to a PDSCH reception starting from an application time after the single DCI. Accordingly, the base station 102, the TX processor 316, or the controller/processor 375 executing the unified TCI control component 120 or the DCI component 122 may provide means for transmitting a single DCI for the UE that is configured with a first unified transmission TCI state for a first TRP and second unified TCI state for a second TRP, wherein the DCI includes a dynamic TCI selection field that indicates whether the first unified TCI state or the second unified

TCI state is applicable to a PDSCH reception starting from an application time after the single DCI.

At block 1420, the method 1400 may optionally include transmitting a PDSCH reception after the single DCI but prior to the application time based on a value of the dynamic TCI selection field prior to the second DCI or a default rule specified in a standards document, regulation, or RRC configuration to select the first updated unified TCI state, the second updated unified TCI state, or both for the PDSCH reception. In some implementations, for example, the base station 102, the TX processor 316, or the controller/processor 375 may execute the unified TCI control component 120 or the communication component 126 to transmit a PDSCH reception after the single DCI but prior to the application time based on a value of the dynamic TCI selection field prior to the second DCI or a default rule specified in a standards document, regulation, or RRC configuration to select the first updated unified TCI state, the second updated unified TCI state, or both for the PDSCH reception. Accordingly, the base station 102, the TX processor 316, or the controller/processor 375 executing the unified TCI control component 120 or communication component 126 may provide means for transmitting a PDSCH reception after the single DCI but prior to the application time based on a value of the dynamic TCI selection field prior to the second DCI or a default rule specified in a standards document, regulation, or RRC configuration to select the first updated unified TCI state, the second updated unified TCI state, or both for the PDSCH reception.

At block 1430, the method 1300 includes transmitting the PDSCH reception after the application time with at least one of the first TRP or the second TRP based on the first unified TCI state or the second unified TCI state as indicated by the dynamic TCI selection field. In some implementations, for example, the base station 102, the TX processor 316, or the controller/processor 375 may execute the unified TCI control component 120 or the communication component 126 to transmit the PDSCH reception after the application time with at least one of the first TRP or the second TRP based on the first unified TCI state or the second unified TCI state as indicated by the dynamic TCI selection field. In some implementations, at sub-block 1432, the block 1430 may optionally include transmitting a PDSCH reception after the application time based on the first unified TCI state, the second unified TCI state, or both based on one of a TCI field included in the single DCI, the first unified TCI state or the second unified TCI state that is active during a slot of the PDSCH, or the first unified TCI state or the second unified TCI state that is active during a slot on which the single DCI is received. Accordingly, the base station 102, the TX processor 316, or the controller/processor 375 executing the unified TCI control component 120 or the communication component 126 may provide means for transmitting the PDSCH reception after the application time with at least one of the first TRP or the second TRP based on the first unified TCI state or the second unified TCI state as indicated by the dynamic TCI selection field.

The following numbered Aspects provide an overview of aspects of the present disclosure:

Aspect 1. A method of wireless communication at a user equipment (UE), comprising: receiving a single downlink control information (DCI) for the UE that is configured with a first unified transmission configuration indication (TCI) state for a first transmit receive point (TRP) and second unified TCI state for a second TRP, wherein the DCI includes at least a first TCI field; updating a configuration of at least one of the first unified TCI state to a first updated unified TCI state or the second unified TCI state to a second updated unified TCI state based on the at least one TCI field; and communicating with at least one of the first TRP or the second TRP based on the first updated unified TCI state or the second updated unified TCI state.

Aspect 2. The method of Aspect 1, wherein the first TCI field is applicable to both the first TRP and the second TRP.

Aspect 3. The method of Aspect 1, wherein the first TCI field is applicable to one of the first TRP or the second TRP.

Aspect 4. The method of Aspect 3, wherein the single DCI further includes a second field that associates the first TCI field to the one of the first TRP or the second TRP, wherein updating the configuration comprises updating only the first TCI state or the second TCI state associated with the first TCI field.

Aspect 5. The method of Aspect 4, wherein communicating with at least one of the first TRP or the second TRP comprises communicating with only the first TRP or the second TRP that is associated with the first TCI field.

Aspect 6. The method of Aspect 4, wherein communicating with at least one of the first TRP or the second TRP comprises communicating with both the first TRP and the second TRP.

Aspect 7. The method of Aspect 3, wherein the single DCI further includes a second TCI field that is applicable to the second TRP, wherein updating the configuration comprises updating a configuration of the second TRP to the second updated unified TCI state based on the second TCI field.

Aspect 8. The method of any of Aspects 1-7, further comprising receiving a second DCI that includes a dynamic TCI selection field that indicates whether the first unified TCI state or the second unified TCI state is applicable to a physical downlink shared channel (PDSCH) reception starting from an application time after the second DCI.

Aspect 9. The method of Aspect 8, wherein the dynamic TCI selection field is applicable to any PDSCH reception associated with the first unified TCI state or the second unified TCI state after the application time until another TCI selection field is received.

Aspect 10. The method of Aspect 9, wherein the second DCI does not include a downlink assignment for a PDSCH reception.

Aspect 11. The method of Aspect 8, wherein the dynamic TCI selection field is applicable to only a PDSCH reception scheduled by the second DCI.

Aspect 12. The method of any of Aspects 8-11, further comprising receiving a radio resource control (RRC) configuration message indicating presence of the dynamic TCI selection field within a DCI format.

Aspect 13. The method of any of Aspects 8-12, wherein the application time is based on a capability of the UE.

Aspect 14. The method of any of Aspects 8-12, wherein the application time is based on a configured time duration for quasi-co-location (QCL) parameter.

Aspect 15. The method of any of Aspects 8-14, further comprising receiving a PDSCH reception after the second DCI but prior to the application time based on a value of the dynamic TCI selection field prior to the second DCI or a default rule specified in a standards document, regulation, or RRC configuration to select the first updated unified TCI state, the second updated unified TCI state, or both for the PDSCH reception.

Aspect 16. The method of any of Aspects 8-14, further comprising receiving a PDSCH reception after the application time based on the first unified TCI state, the second unified TCI state, or both based on one of a TCI field included in the second DCI, the first unified TCI state or the second unified TCI state that is active during a slot of the PDSCH, or the first unified TCI state or the second unified TCI state that is active during a slot on which the second DCI is received.

Aspect 17. The method of any of Aspects 1-16, wherein communicating with the at least one of the first TRP or the second TRP based on the first updated unified TCI state or the second updated unified TCI state comprises applying a default rule specified in a standards document, regulation, or RRC configuration to select the first unified TCI state, the second unified TCI state, or both for a PDSCH reception.

Aspect 18. The method of Aspect 17, wherein the default rule indicates selecting both the first unified TCI state and the second unified TCI state in an absence of an indication of a single TCI state for the PDSCH reception.

Aspect 19. The method of Aspect 18, wherein the default rule indicates selection of a configured and activated codepoint with a lowest index value that is associated with two unified TCI states.

Aspect 20. The method of any of Aspects 17-19, further comprising transmitting an indication of a capability of the UE to support the default rule.

Aspect 21. The method of any of Aspects 17-20, further comprising applying the default rule before the UE receives any DCI indicating the first unified TCI or the second unified TCI, after initial access or after a beam failure recovery.

Aspect 22. The method of any of Aspects 17-21, further comprising receiving a second DCI that schedules a physical downlink shared channel (PDSCH) reception, the second DCI does not include a dynamic TCI selection field that indicates whether the first unified TCI state or the second unified TCI state is applicable to the PDSCH reception.

Aspect 23. The method of Aspect 22, wherein a format of the second DCI is format 1_1 or 1_2, and wherein the default rule indicates that all indicated TCI states are applied to the scheduled PDSCH.

Aspect 24. The method of Aspect 22, wherein a format of the second DCI is format 1_0, wherein the default rule indicates to apply two TCI states of a scheduling CORESET if the scheduling CORESET is indicated for scheduling SFN transmissions.

Aspect 25. The method of Aspect 22, wherein a format of the second DCI is format 1_0, wherein two scheduling CORESETs are configured with PDCCH repetition with two linked search spaces, and wherein the default rule indicates to select a TCI state of a scheduling CORESET with a lowest ID for the PDSCH.

Aspect 26. The method of Aspect 22, wherein a format of the second DCI is format 1_0, and wherein the default rule indicates to apply a TCI state of a scheduling CORESET.

Aspect 27. The method of any of Aspects 1-26, wherein the first unified TCI state or the second unified TCI state is applicable to both a control channel and a shared channel in an uplink direction, a downlink direction, or both the uplink direction and the downlink direction.

Aspect 28. A method of wireless communication at a user equipment (UE), comprising: receiving a single downlink control information (DCI) for the UE that is configured with a first unified transmission control indicator (TCI) state for a first transmit receive point (TRP) and second unified TCI state for a second TRP, wherein the DCI includes a dynamic TCI selection field that indicates whether the first unified TCI state or the second unified TCI state is applicable to a physical downlink shared channel (PDSCH) reception starting from an application time after the single DCI; and receiving the PDSCH reception after the application time with at least one of the first TRP or the second TRP based on the first unified TCI state or the second unified TCI state as indicated by the dynamic TCI selection field.

Aspect 29. A method of wireless communication at a base station, comprising: transmitting a single downlink control information (DCI) to a user equipment (UE) that is configured with a first unified transmission configuration indication (TCI) state for a first transmit receive point (TRP) and second unified TCI state for a second TRP, wherein the DCI includes at least a first TCI field; updating a configuration of the UE for at least one of the first unified TCI state to a first updated unified TCI state or the second unified TCI state to a second updated unified TCI state based on the at least one TCI field; and communicating with the UE via at least one of the first TRP or the second TRP based on the first updated unified TCI state or the second updated unified TCI state.

Aspect 30. The method of Aspect 29, wherein the first TCI field is applicable to both the first TRP and the second TRP.

Aspect 31. The method of Aspect 29, wherein the first TCI field is applicable to one of the first TRP or the second TRP.

Aspect 32. The method of Aspect 31, wherein the single DCI further includes a second field that associates the first TCI field to the one of the first TRP or the second TRP, wherein updating the configuration comprises updating only the first TCI state or the second TCI state associated with the first TCI field.

Aspect 33. The method of Aspect 32, wherein communicating via at least one of the first TRP or the second TRP comprises communicating via only the first TRP or the second TRP that is associated with the first TCI field.

Aspect 34. The method of Aspect 32, wherein communicating with at least one of the first TRP or the second TRP comprises communicating via both the first TRP and the second TRP.

Aspect 35. The method of Aspect 29, wherein the single DCI further includes a second TCI field that is applicable to the second TRP, wherein updating the configuration comprises updating the configuration of the second unified TCI to the second updated unified TCI state based on the second TCI field.

Aspect 36. The method of Aspect 29, further comprising transmitting a second DCI that includes a dynamic TCI selection field that indicates whether the first unified TCI state or the second unified TCI state is applicable to a physical downlink shared channel (PDSCH) reception starting from an application time after the second DCI.

Aspect 37. The method of Aspect 36, wherein the dynamic TCI selection field is applicable to any PDSCH reception associated with the first unified TCI state or the second unified TCI state after the application time until another TCI selection field is received.

Aspect 38. The method of Aspect 37, wherein the second DCI does not include a downlink assignment for a PDSCH reception.

Aspect 39. The method of Aspect 36, wherein the dynamic TCI selection field is applicable to only a PDSCH reception scheduled by the second DCI.

Aspect 40. The method of any of Aspects 36-39, further comprising transmitting a radio resource control (RRC) configuration message indicating presence of the dynamic TCI selection field within a DCI format.

Aspect 41. The method of any of Aspects 36-40, wherein the application time is based on a capability of the UE.

Aspect 42. The method of any of Aspects 36-41, wherein the application time is based on a configured time duration for quasi-co-location (QCL) parameter.

Aspect 43. The method of any of Aspects 36-42, further comprising transmitting a PDSCH after the second DCI but prior to the application time based on a value of the dynamic TCI selection field prior to the second DCI or a default rule specified in a standards document, regulation, or RRC configuration to select the first updated unified TCI state, the second updated unified TCI state, or both for reception of the PDSCH.

Aspect 44. The method of any of Aspects 36-42, further comprising transmitting a PDSCH after the application time based on the first unified TCI state, the second unified TCI state, or both based on one of a TCI field included in the second DCI, the first unified TCI state or the second unified TCI state that is active during a slot of the PDSCH, or the first unified TCI state or the second unified TCI state that is active during a slot on which the second DCI is transmitted.

Aspect 45. The method of Aspects 29-44, wherein communicating via the at least one of the first TRP or the second TRP based on the first updated unified TCI state or the second updated unified TCI state comprises applying a default rule specified in a standards document, regulation, or RRC configuration to select the first unified TCI state, the second unified TCI state, or both for a PDSCH reception.

Aspect 46. The method of Aspect 45, wherein the default rule indicates selecting both the first unified TCI state and the second unified TCI state in an absence of an indication of a single TCI state for the PDSCH reception.

Aspect 47. The method of Aspect 46, wherein the default rule indicates selection of a configured and activated codepoint with a lowest index value that is associated with two unified TCI states.

Aspect 48. The method of any of Aspects 45-47, further comprising receiving an indication of a capability of the UE to support the default rule.

Aspect 49. The method of any of Aspects 45-48, further comprising applying the default rule before the UE receives any DCI indicating the first unified TCI or the second unified TCI, after initial access, or after a beam failure recovery.

Aspect 50. The method of any of Aspects 45-49, further comprising transmitting a second DCI that schedules a physical downlink shared channel (PDSCH) reception, the second DCI does not include a dynamic TCI selection field that indicates whether the first unified TCI state or the second unified TCI state is applicable to the PDSCH reception.

Aspect 51. The method of Aspect 50, wherein a format of the second DCI is format 1_1 or 1_2, and wherein the default rule indicates that all indicated TCI states are applied to the scheduled PDSCH.

Aspect 52. The method of Aspect 50, wherein a format of the second DCI is format 1_0, wherein the default rule indicates to apply two TCI states of a scheduling CORESET if the scheduling CORESET is indicated for scheduling SFN transmissions.

Aspect 53. The method of Aspect 50, wherein a format of the second DCI is format 1_0, wherein two scheduling CORESETs are configured with PDCCH repetition with two linked search spaces, and wherein the default rule indicates to select a TCI state of a scheduling CORESET with a lowest ID for the PDSCH.

Aspect 54. The method of Aspect 50, wherein a format of the second DCI is format 1_0, and wherein the default rule indicates to apply a TCI state of a scheduling CORESET.

Aspect 55. The method of any of Aspects 29-54, wherein the unified TCI state is applicable to both a control channel and a shared channel in an uplink direction, a downlink direction, or both the uplink direction and the downlink direction.

Aspect 56. A method of wireless communication at a base station, comprising: transmitting a single downlink control information (DCI) to a user equipment (UE) that is configured with a first unified transmission control indicator (TCI) state for a first transmit receive point (TRP) and second unified TCI state for a second TRP, wherein the DCI includes a dynamic TCI selection field that indicates whether the first unified TCI state or the second unified TCI state is applicable to a physical downlink shared channel (PDSCH) reception starting from an application time after the single DCI; and transmitting the PDSCH after the application time via at least one of the first TRP or the second TRP based on the first unified TCI state or the second unified TCI state as indicated by the dynamic TCI selection field.

Aspect 57. An apparatus for wireless communication, comprising: a transceiver; a memory storing computer-executable instructions; and a processor coupled with the transceiver and the memory and configured to: execute the computer-executable instructions to execute the instructions to perform the method of any of Aspects 1-28.

Aspect 58. An apparatus for wireless communication, comprising: a transceiver; a memory storing computer-executable instructions; and a processor coupled with the transceiver and the memory and configured to execute the computer-executable instructions to perform the method of any of Aspects 29-56.

Aspect 59. An apparatus for wireless communication, comprising means for performing the method of any of Aspects 1-28.

Aspect 60. An apparatus for wireless communication, comprising means for performing the method of any of Aspects 29-56.

Aspect 61. A non-transitory computer-readable medium storing computer-executable instructions that when executed by a processor of a user equipment (UE) cause the UE to perform the method of any of Aspects 1-28.

Aspect 62. A non-transitory computer-readable medium storing computer-executable instructions that when executed by a processor of a network entity cause the network entity to perform the method of any of Aspects 29-56.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of wireless communication at a user equipment (UE), comprising:
receiving a single downlink control information (DCI) for the UE that is configured with a first unified transmission configuration indication (TCI) state for a first transmit receive point (TRP) and second unified TCI state for a second TRP, wherein the DCI includes at least a first TCI field;
updating a configuration of at least one of the first unified TCI state to a first updated unified TCI state or the second unified TCI state to a second updated unified TCI state based on the at least one TCI field; and
communicating with at least one of the first TRP or the second TRP based on the first updated unified TCI state or the second updated unified TCI state.

2. The method of claim 1, wherein the first TCI field is applicable to one of the first TRP or the second TRP.

3. The method of claim 2, wherein the single DCI further includes a second field that associates the first TCI field to the one of the first TRP or the second TRP, wherein updating the configuration comprises updating only the first TCI state or the second TCI state associated with the first TCI field.

4. The method of claim 3, wherein communicating with at least one of the first TRP or the second TRP comprises communicating with both the first TRP and the second TRP.

5. The method of claim 1, further comprising receiving a second DCI that includes a dynamic TCI selection field that indicates whether the first unified TCI state or the second unified TCI state is applicable to a physical downlink shared channel (PDSCH) reception starting from an application time after the second DCI.

6. The method of claim 1, wherein communicating with the at least one of the first TRP or the second TRP based on the first updated unified TCI state or the second updated unified TCI state comprises applying a default rule specified in a standards document, regulation, or RRC configuration to select the first unified TCI state, the second unified TCI state, or both for a PDSCH reception.

7. The method of claim 6, wherein the default rule indicates selecting both the first unified TCI state and the second unified TCI state in an absence of an indication of a single TCI state for the PDSCH reception.

8. The method of claim 7, wherein the default rule indicates selection of a configured and activated codepoint with a lowest index value that is associated with two unified TCI states.

9. The method of claim 1, wherein the first unified TCI state or the second unified TCI state is applicable to both a control channel and a shared channel in an uplink direction, a downlink direction, or both the uplink direction and the downlink direction.

10. A method of wireless communication at a base station, comprising:
transmitting a single downlink control information (DCI) to a user equipment (UE) that is configured with a first unified transmission configuration indication (TCI) state for a first transmit receive point (TRP) and second unified TCI state for a second TRP, wherein the DCI includes at least a first TCI field;
updating a configuration of the UE for at least one of the first unified TCI state to a first updated unified TCI state or the second unified TCI state to a second updated unified TCI state based on the at least one TCI field; and
communicating with the UE via at least one of the first TRP or the second TRP based on the first updated unified TCI state or the second updated unified TCI state.

11. The method of claim 10, wherein the first TCI field is applicable to one of the first TRP or the second TRP.

12. The method of claim 11, wherein the single DCI further includes a second field that associates the first TCI field to the one of the first TRP or the second TRP, wherein updating the configuration comprises updating only the first TCI state or the second TCI state associated with the first TCI field.

13. The method of claim 12, wherein communicating with at least one of the first TRP or the second TRP comprises communicating via both the first TRP and the second TRP.

14. The method of claim 10, further comprising transmitting a second DCI that includes a dynamic TCI selection field that indicates whether the first unified TCI state or the second unified TCI state is applicable to a physical downlink shared channel (PDSCH) reception starting from an application time after the second DCI.

15. The method of claim 10, wherein communicating via the at least one of the first TRP or the second TRP based on the first updated unified TCI state or the second updated unified TCI state comprises applying a default rule specified in a standards document, regulation, or RRC configuration to select the first unified TCI state, the updated unified TCI state, or both for a PDSCH reception.

16. The method of claim 15, wherein the default rule indicates selecting both the first unified TCI state and the second unified TCI state in an absence of an indication of a single TCI state for the PDSCH reception.

17. The method of claim 16, wherein the default rule indicates selection of a configured and activated codepoint with a lowest index value that is associated with two unified TCI states.

18. The method of claim 10, wherein the unified TCI state is applicable to both a control channel and a shared channel in an uplink direction, a downlink direction, or both the uplink direction and the downlink direction.

19. An apparatus for wireless communication at a user equipment (UE), comprising:
one or more memories, individually or in combination, storing computer-executable instructions; and
one or more processors coupled with the one or more memories and, individually or in combination, configured to:
receive a single downlink control information (DCI) for the UE that is configured with a first unified transmission configuration indication (TCI) state for a first transmit receive point (TRP) and second unified TCI state for a second TRP, wherein the DCI includes at least a first TCI field;
update a configuration of at least one of the first unified TCI state to a first updated unified TCI state or the second unified TCI state to a second updated unified TCI state based on the at least one TCI field; and
communicate with at least one of the first TRP or the second TRP based on the first updated unified TCI state or the second updated unified TCI state.

20. The apparatus of claim 19, wherein the first TCI field is applicable to one of the first TRP or the second TRP.

21. The apparatus of claim 20, wherein the single DCI further includes a second field that associates the first TCI field to the one of the first TRP or the second TRP, wherein updating the configuration comprises updating only the first TCI state or the second TCI state associated with the first TCI field.

22. The apparatus of claim 21, wherein communicating with at least one of the first TRP or the second TRP comprises communicating with both the first TRP and the second TRP.

23. The apparatus of claim 19, wherein the one or more processors, individually or in combination, are further configured to receive a second DCI that includes a dynamic TCI selection field that indicates whether the first unified TCI state or the second unified TCI state is applicable to a physical downlink shared channel (PDSCH) reception starting from an application time after the second DCI.

24. The apparatus of claim 19, wherein to communicate with the at least one of the first TRP or the second TRP based on the first updated unified TCI state or the second updated unified TCI state, the one or more processors, individually or in combination, are configured to apply a default rule specified in a standards document, regulation, or RRC configuration to select the first unified TCI state, the second unified TCI state, or both for a PDSCH reception.

25. The apparatus of claim 24, wherein the default rule indicates selecting both the first unified TCI state and the second unified TCI state in an absence of an indication of a single TCI state for the PDSCH reception.

26. The apparatus of claim 25, wherein the default rule indicates selection of a configured and activated codepoint with a lowest index value that is associated with two unified TCI states.

27. The apparatus of claim 19, wherein the first unified TCI state or the second unified TCI state is applicable to both a control channel and a shared channel in an uplink direction, a downlink direction, or both the uplink direction and the downlink direction.

28. An apparatus for wireless communication at a network node, comprising:
one or more memories, individually or in combination, storing computer-executable instructions; and
one or more processors coupled with the one or more memories and configured to execute the computer-executable instructions to:
transmit a single downlink control information (DCI) to a user equipment (UE) that is configured with a first unified transmission configuration indication (TCI) state for a first transmit receive point (TRP) and second unified TCI state for a second TRP, wherein the DCI includes at least a first TCI field;
update a configuration of the UE for at least one of the first unified TCI state to a first updated unified TCI state or the second unified TCI state to a second updated unified TCI state based on the at least one TCI field; and
communicate with the UE via at least one of the first TRP or the second TRP based on the first updated unified TCI state or the second updated unified TCI state.

29. The apparatus of claim 28, wherein the first TCI field is applicable to one of the first TRP or the second TRP, wherein the single DCI further includes a second field that associates the first TCI field to the one of the first TRP or the second TRP, and wherein the one or more processors, individually or in combination, are configured to:
update only the first TCI state or the second TCI state associated with the first TCI field; and
communicate via both the first TRP and the second TRP.

30. The apparatus of claim 28, wherein the one or more processors, individually or in combination, are configured to apply a default rule specified in a standards document, regulation, or RRC configuration to select both the first unified TCI state and the second unified TCI state in an absence of an indication of a single TCI state for a PDSCH reception.
